(19) United States
(12) Patent Application Publication
(10) Pub. No.: US 2026/0172408 A1
(43) Pub. Date: Jun. 18, 2026

(54) SERVER APPARATUS, SYSTEM, CONTROL METHOD OF SERVER APPARATUS, AND STORAGE MEDIUM

(71) Applicant: NEC Corporation, Minato-ku, Tokyo (JP)

(72) Inventors: Daisuke SHIBUICHI, Tokyo (JP); Yoshihisa SHINGU, Tokyo (JP); Issei YANAGISAWA, Tokyo (JP); Tomohide OTA, Tokyo (JP)

(73) Assignee: NEC Corporation, Minato-ku, Tokyo (JP)

(21) Appl. No.: 19/122,349

(22) PCT Filed: Nov. 1, 2022
(86) PCT No.: PCT/JP2022/040916

§ 371 Date: Apr. 18, 2025

(51) Int. Cl. H04L 9/40

(52) U.S. Cl. CPC H04L 63/08

(57) ABSTRACT

A server apparatus includes a service selection control means and a user registration control means. The service selection control means enables a user to select a service provider from which the user wishes to receive a service using a predetermined code from among a plurality of service providers that provide services using biometric authentication. The user registration control means performs control so that the service provider selected by the user acquires original biometric information that serves as an original of authentication information to be used for the biometric authentication.

### TECHNICAL FIELD

The present invention relates to a server apparatus, a system, a control method of a server apparatus, and a storage medium.

### BACKGROUND ART

There exists technology related to biometric authentication.

For example, Patent Literature 1 describes providing a biometric matching system that enables biometric information of a user to be appropriately matched, while improving convenience for the user. The biometric matching system of Patent Literature 1 includes a plurality of mobile terminals and a biometric matching apparatus. The biometric matching apparatus includes a storage unit, an acquiring unit, a receiving unit, an extraction unit, and a matching unit. The storage unit stores a registered biometric image of a user of each mobile terminal in association with identification information of each mobile terminal. The acquiring unit acquires input biometric information of a specific user. The receiving unit receives a location signal or a wireless signal from each mobile terminal. The extraction unit detects two or more mobile terminals within a predetermined range from a biometric matching apparatus based on the received location signal or wireless signal, and extracts two or more registered biometric images associated with the identification information of the detected mobile terminals from the registered biometric images stored in the storage unit, respectively. The matching unit matches the respective input biometric information with the extracted registration biometric images.

Patent Literature 2 describes performing face recognition of a user for each event that may occur within a facility in a simplified manner, while securely managing personal information of users who use the facility. A face recognition system of Patent Literature 2 includes a registration apparatus, a face recognition machine, a face management server, and a face matching server. The registration apparatus acquires a face image for registration of a user of a facility and identifying information used to identify the user. The face recognition machine acquires a face image for authentication of the user captured at the time of an event. The face management server is connected to the registration apparatus via a network and associates and accumulates the face image for registration and the identifying information. The face matching server generates facial feature value data from the face image for registration and the face image for authentication, respectively, and performs a matching processing between the facial feature value data.

### CITATION LIST

### Patent Literature

[PTL 1] Japanese Unexamined Patent Application Publication No. JP2017-059060
[PTL 2] Japanese Unexamined Patent Application Publication No. JP2020-144443

### SUMMARY OF INVENTION

### Technical Problem

In recent years, various services using biometric authentication have begun to be provided. Users need to register their biometric information (for example, face image) in the server before receiving a service using biometric authentication. At that time, to receive services from each of a plurality of service providers (for example, retailers and transportation business operators), the users need to register their biometric information with each service provider.

Here, each service provider differs in the presence or absence of accounts for managing customers and in the type, and so on, of operation information at the time of providing services to customers, depending on its business model. Therefore, a method of registering biometric information (registration method) suitable for each type of service provider is requested.

It is a main object of the present invention to provide a server apparatus, a system, a control method of a server apparatus, and a storage medium that contribute to realizing registration of biometric information suitable for a type of a service provider.

### Solution to Problem

According to a first aspect of the present invention, there is provided a server apparatus, including: a service selection control means that enables a user to select a service provider from which the user wishes to receive a service using a predetermined code from among a plurality of service providers that provide services using biometric authentication; and a user registration control means that performs control so that the service provider selected by the user acquires original biometric information that serves as an original of authentication information to be used for the biometric authentication.

According to a second aspect of the present invention, there is provided a system, including: a terminal possessed by a user; and a server apparatus, wherein the server apparatus, including: a service selection control means that enables a user to select a service provider from which the user wishes to receive a service using a predetermined code from among a plurality of service providers that provide services using biometric authentication; and a user registration control means that performs control so that the service provider selected by the user acquires original biometric information that serves as an original of authentication information to be used for the biometric authentication, wherein the user registration control means acquires the original biometric information by requesting the terminal possessed by the user to provide the original biometric information, and transmits the acquired original biometric information to a server of the service provider selected by the user.

According to a third aspect of the present invention, there is provided a control method of a server apparatus, the control method including: enabling a user to select a service provider from which the user wishes to receive a service using a predetermined code from among a plurality of service providers that provide services using biometric authentication; and performing control so that the service provider selected by the user acquires original biometric information that serves as an original of authentication information to be used for the biometric authentication.

According to a fourth aspect of the present invention, there is provided a computer-readable storage medium storing a program causing a computer mounted on a server apparatus to perform processing for: enabling a user to select a service provider from which the user wishes to receive a service using a predetermined code from among a plurality of service providers that provide services using biometric authentication; and performing control so that the service provider selected by the user acquires original biometric information that serves as an original of authentication information to be used for the biometric authentication.

### Advantageous Effects of Invention

The individual aspects of the present invention provide a server apparatus, a system, a control method of a server apparatus, and a storage medium are provided that contribute to realizing registration of biometric information suitable for a type of a service provider. The advantageous effect of the present invention is not limited to the above advantageous effect. The present invention may provide other advantageous effects, instead of or in addition to the above advantageous effect.

### BRIEF DESCRIPTION OF THE DRAWINGS

FIG. 1 is a diagram illustrating an outline of an example embodiment.

FIG. 2 is a flowchart illustrating an example of an operation of an example embodiment.

FIG. 3 is a diagram illustrating an example of a schematic configuration of an authentication system according to a first example embodiment.

FIG. 4 is a diagram illustrating an operation of the authentication system according to the first example embodiment.

FIG. 5 is a diagram illustrating the operation of the authentication system according to the first example embodiment.

FIG. 6 is a diagram illustrating the operation of the authentication system according to the first example embodiment.

FIG. 7 is a diagram illustrating an example of a processing configuration of a control server according to the first example embodiment.

FIG. 8 is a diagram illustrating an example embodiment of an account management database according to the first example embodiment.

FIG. 9 is a diagram illustrating an example of a display of a terminal according to the first example embodiment.

FIG. 10 is a diagram illustrating an example of the display of the terminal according to the first example embodiment.

FIG. 11 is a diagram illustrating an example of an operation of a control server according to the first example embodiment.

FIG. 12 is a diagram illustrating an example of a processing configuration of a service server according to the first example embodiment.

FIG. 13 is a diagram illustrating an example of a user management database according to the first example embodiment.

FIG. 14 is a diagram illustrating an example of a processing configuration of an authentication terminal according to the first example embodiment.

FIG. 15 is a diagram illustrating an example of a processing configuration of the terminal according to the first example embodiment.

FIG. 16 is a diagram illustrating an example of the display of the terminal according to the first example embodiment.

FIG. 17 is a diagram illustrating an example of the operation of the authentication system according to the first example embodiment.

FIG. 18 is a diagram illustrating an operation of the authentication system according to a second example embodiment.

FIG. 19 is a diagram illustrating an example of a display of the terminal according to the second example embodiment.

FIG. 20 is a diagram illustrating an operation of the authentication system according to the second example embodiment.

FIG. 21 is a diagram illustrating an operation of the authentication system according to a third example embodiment.

FIG. 22 is a diagram illustrating the operation of the authentication system according to the third example embodiment.

FIG. 23 is a diagram illustrating the operation of the authentication system according to the third example embodiment.

FIG. 24 is a sequence diagram illustrating an example of the operation of the authentication system according to the third example embodiment.

FIG. 25 is a diagram illustrating an operation of the authentication system according to a fourth example embodiment.

FIG. 26 is a diagram illustrating an example of a display of the terminal according to the fourth example embodiment.

FIG. 27 is a diagram illustrating an example of a hardware configuration of the control server of the present application disclosed.

FIG. 28 is a diagram illustrating an example of a display of the terminal according to a variation of the present application disclosed.

FIG. 29 is a diagram illustrating an example of a schematic configuration of the authentication system according to the variation of the present application disclosed.

FIG. 30 is a diagram illustrating an example of the schematic configuration of the authentication system according to the variation of the present application disclosed.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

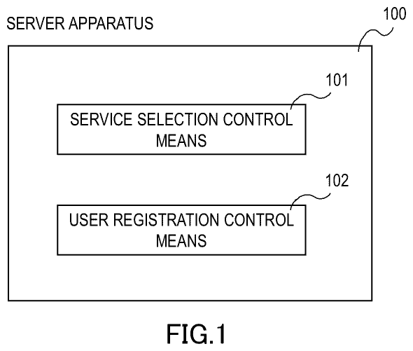

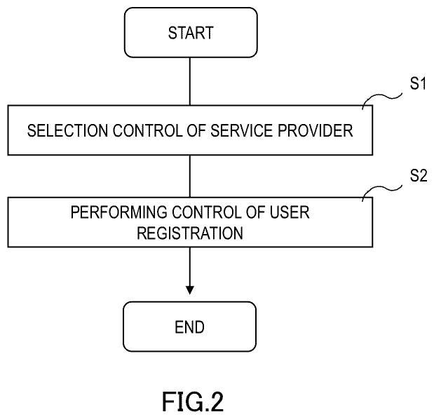

A server apparatus 100 according to an example embodiment includes a service selection control means 101 and a user registration control means 102 (see FIG. 1). The service selection control means 101 enables a user to select a service provider from which the user wishes to receive a service using a predetermined code from among a plurality of service providers that provide services using biometric authentication (selection control of service provider; step S1 in FIG. 2). The user registration control means 102 performs control so that the service provider selected by the user acquires original biometric information that serves as an original of authentication information to be used for the biometric authentication (performing control of user registration; step S2).

As described above, there are various types of service providers that provide a service using biometric authentication to a user. For example, the types of service providers can be categorized based on the presence or absence of accounts for managing customers (a portal site where customers log in) and how operation information is used to provide a service using biometric authentication. Furthermore, due to changes in user awareness of personal information protection, there are authentication systems in which original biometric information (for example, a face image) that serves as the original of authentication information in biometric authentication is stored in a terminal such as a smartphone and the user manages the original biometric information himself/herself. In such an authentication system, consider a case in which, for example, a user wishes to receive a service from a service provider who does not have accounts for managing customers. Here, there are many service providers who do not have accounts to manage customers, and the user has difficulty in specifying a desired service provider. Therefore, the user selects a service provider using a predetermined code (management code described below). The server apparatus 100 performs user registration control so that the service provider selected by the predetermined code acquires and registers the original biometric information of the user. For example, it is assumed that the above service provider is a workplace of the user or a condominium management company, and so on. The server apparatus 100 acquires the original biometric information from a terminal of the user and transmits the acquired original biometric information to a server of the service provider. In other words, the server apparatus 100 is provided that realizes registration of biometric information suitable for the type of service provider.

Hereinafter, specific example embodiments will be described in more detail with reference to drawings.

### First Example Embodiment

A first example embodiment will be described in more detail with reference to drawings.

### System Configuration

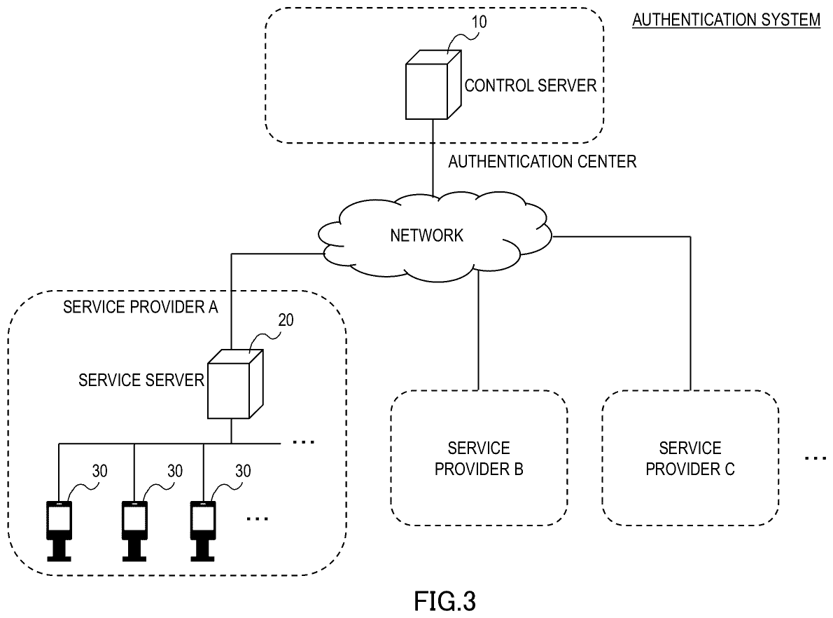

FIG. 3 is a diagram illustrating an example of a schematic configuration of an authentication system (information processing system) according to a first example embodiment. As illustrated in FIG. 3, the authentication system includes a plurality of service providers A through C, and an authentication center.

The service provider is a business operator that provides a service to a user by using biometric authentication. In an authentication system according to the present application, it is assumed that service providers belonging to various business types or fields provide services by using biometric authentication. It should be noted that any services provided by the service provider may be either paid or free of charge.

For example, examples of the service providers include business operators that provide a rental housing service such as condominiums, business operators that are workplaces of their employees (users' workplaces), business operators that provide events such as concerts, and business operators that operate transportation means such as airplanes. Alternatively, the business operators that provide accommodation services, business operators such as retail stores, business operators that provide financial services, and educational business operators are also included in the service providers of the present application. In addition, the service providers are not limited to private business operators. Municipalities and other public agencies may be the service providers.

The authentication center is an entity that performs control, management, and so on related to biometric authentication for each of the plurality of service providers. The business operator (service provider) that wishes to provide a service using biometric authentication to a user (general consumer) must enter into a contract with the authentication center.

The authentication center includes a control server 10. The control server 10 realizes a main function of the authentication center. The control server 10 may be installed in a building of the authentication center, or may be a server installed on a network (on a cloud).

As described above, the service provider provides services to users using biometric authentication. For example, biometric authentication is performed at the time a user goes to work in an office or returns home to a condominium, allowing users (employees and residents) who have legitimate credentials to enter the office, and so on. Or, biometric authentication is performed for checking a ticket at an event venue, check-in procedures at a hotel, immigration procedures at an airport, and so on. In such services (procedures), services are provided to the users who have legitimate credentials. Alternatively, biometric authentication can be used for payment procedures at a retail store, and so on.

As illustrated in FIG. 3, each service provider includes a service server 20 and at least one or more authentication terminals 30. Apparatuses (the service server 20, the authentication terminal 30) provided by the service provider are connected to each other for mutual communication. Specifically, the service server 20 and authentication terminal 30 are connected by wired or wireless communication means.

The service server 20 is connected to the control server 10 via a network. The service server 20 may be located in a building of the service provider or on a cloud.

The service server 20 stores the information necessary to provide a service to a user. Specifically, the service server 20 stores operation information necessary for each service provider to provide a service using biometric authentication and information necessary for biometric authentication. The service server 20 uses a user management database to store the operation information and information necessary for biometric authentication. Details of the user management database will be described below.

For example, the service server 20 of a company where a user works stores name, date of birth, employee number, department, and work location, and so on of the user (employee) as the operation information. Moreover, the service server 20 of an event company that hosts an event stores information related to a ticket purchased by an event participant as the operation information. Furthermore, the service server 20 of a retail store, and so on stores credit card information, and so on necessary for payment settlement as the operation information.

Details of information necessary for biometric authentication stored in the service server 20 will be described later.

The authentication terminal 30 is an apparatus that serves as an interface for a user receiving a service. The authentication terminal 30 is installed at a location where each service provider provides its service. More specifically, the authentication terminals 30 are installed in stores or other locations that users actually visit.

The authentication terminal 30 has a function and form appropriate to the type of business, and so on of the service provider. For example, the authentication terminal 30 installed at a workplace or event venue can be a gate apparatus equipped with a gate that restricts passage of a user (person to be authenticated). Also, the authentication terminal 30 installed in a retail store can be a tablet-type terminal.

The configuration illustrated in FIG. 3 is an example and does not limit the configuration or the like of the authentication system disclosed in the present application. For example, the authentication center may include two or more control servers 10. Furthermore, it is sufficient that at least one or more service providers participate in the authentication system. Furthermore, it is sufficient that each service provider includes at least one or more service servers 20 and at least one or more authentication terminals 30.

### Outline of Operation

Next, a schematic operation in the authentication system according to the first example embodiment will be described.

### Account Generation

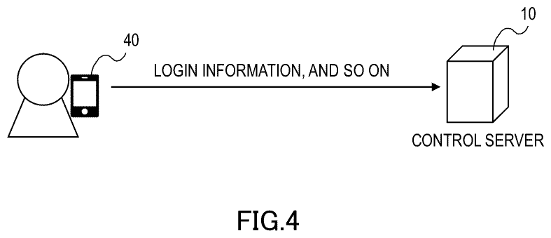

A user who wishes to receive a service from a service provider is required to create an account in the system. Specifically, the user accesses the control server 10 by operating a terminal 40 in his/her possession (see FIG. 4).

The user inputs login information (for example, login ID and password), name, date of birth, and so on, on a web (web) page provided by the control server 10. Once the control server 10 acquires the login information and so on, the control server 10 generates an ID to identify the user. Note that in the following description, the ID generated by the control server 10 is described as a “system ID”. The control server 10 stores the generated system ID, login information, and so on in association with each other in an account management database. Details of the account management database will be described below.

### Registration of Biometric Information

A user who wishes to receive a service using biometric authentication is required to register his or her own biometric information with the terminal 40.

Here, in order to provide a service using biometric authentication, authentication information generated from biometric information needs to be registered in advance with a service provider. For example, in cases where a service is provided using face recognition, a feature value (feature vector) generated from a face image needs to be registered in advance as authentication information. Or, in cases where a service is provided using fingerprint authentication, a feature value generated from a fingerprint image needs to be registered in advance as authentication information.

In the following descriptions, information that serves as an original (basis) for generating authentication information, such as face images and fingerprint images, will be referred to as “original biometric information”. A feature value that are generated from the original biometric information and pre-registered will be referred to “registered authentication information”.

After completing the account generation, the user needs to register the original biometric information (for example, a face image) with the terminal 40 in his/her possession. The terminal 40 acquires the original biometric information using a graphical user interface (GUI) or other means. The terminal 40 stores the acquired original biometric information (for example, face image) internally. Thus, the terminal 40 stores the original biometric information that serves as the original of authentication information used for biometric authentication.

### Selection of Service

The user who has completed system registration (account generation) and registration of the original biometric information selects a service provider from which the user wishes to receive a service of a biometric authentication service. The user selects the service provider from which the user wishes to receive a service from among the plurality of service providers participating in the authentication system (service providers that have contracted with the authentication center).

The control server 10 stores information about the service provider participating in the authentication system. For example, the control server 10 stores name, type of business, location, and so on of the service provider. The control server 10 retains information for each of the plurality of service providers and allows the user to select a service provider.

After the user performs a predetermined operation on a portal site by operating the terminal 40, the control server 10 displays on the terminal 40 a GUI or the like that enables the user to select a desired service (a service provider). The control server 10 acquires the service (biometric authentication service) desired by the user using the GUI.

### User Registration

After acquiring the service provider selected by the user, the control server 10 performs control related to “user registration” that enables the selected service provider to provide a service using biometric authentication to the user.

Specifically, the control server 10 performs control for the above selected service provider to acquire the original biometric information stored in the terminal 40 of the user. The service provider generates registered authentication information from the acquired original biometric information, and associates the generated registered authentication information with operation information, thereby becoming ready to provide the service to the user.

Here, as described above, there are various types of service providers, depending on their type of business and business model. In the present application, the service providers participating in the authentication system are categorized into four types.

A service provider belonging to the first type is a business operator that does not have accounts (portal sites) to manage the users who are provided with a service, and uses the same operation information repeatedly. For example, service providers such as a small business (a company where the user works) or a condominium management company, and so on, belong to the first type.

A service operator belonging to the second type is a business operator that does not have accounts (portal sites) to manage the users who are provided with a service, and uses the operation information required for authentication only once, in principle. For example, a business operator that operates an amusement park, theme park, or the like by outsourcing ticket sales to another company (such as a ticket sales operator), or an event company, and so on that holds events such as concerts, belongs to the second type.

A service provider belonging to the third type is a business operator that has accounts (portal sites) for managing the users (customers) who are provided with a service, and also uses the same operation information repeatedly. For example, a service provider such as a retail business operator that sells a product, and so on belongs to the third type.

A service provider belonging to the fourth type is a business operator that has accounts (portal sites) for managing the users who are provided with a service, and also uses the operation information required for authentication only once, in principle. For example, a business operator that sells tickets on its own and operates an amusement park, theme park, or the like, or an event company, and so on that holds events such as concerts, belongs to the fourth type.

The control server 10 performs user registration control in accordance with the type of service provider selected by the user. In the first example embodiment, “user registration” with respect to the above first type will be described.

### First Type of User Registration

A user accesses the control server 10 by operating the terminal 40 and logs in to a portal site of the user. Once the user performs a predetermined operation on the portal site (for example, pressing a button to select a service provider), the control server 10 displays a GUI on the terminal 40 including a list of service providers.

Once the user selects one service provider from among the service providers listed on the terminal 40, the control server 10 acquires information specifying the service provider which is the target of user registration, as necessary. For example, the control server 10 uses a GUI, and so on to acquire from the user a “management code” that specifies the company where the user works or the management company of the condominium in which the user resides. That is, the user operates the terminal 40 and inputs the management code.

Once the service provider which is the target of user registration is identified by the management code, the control server 10 determines the type of the identified service provider. In the first example embodiment, the control server 10 determines that a first type of service provider has been selected.

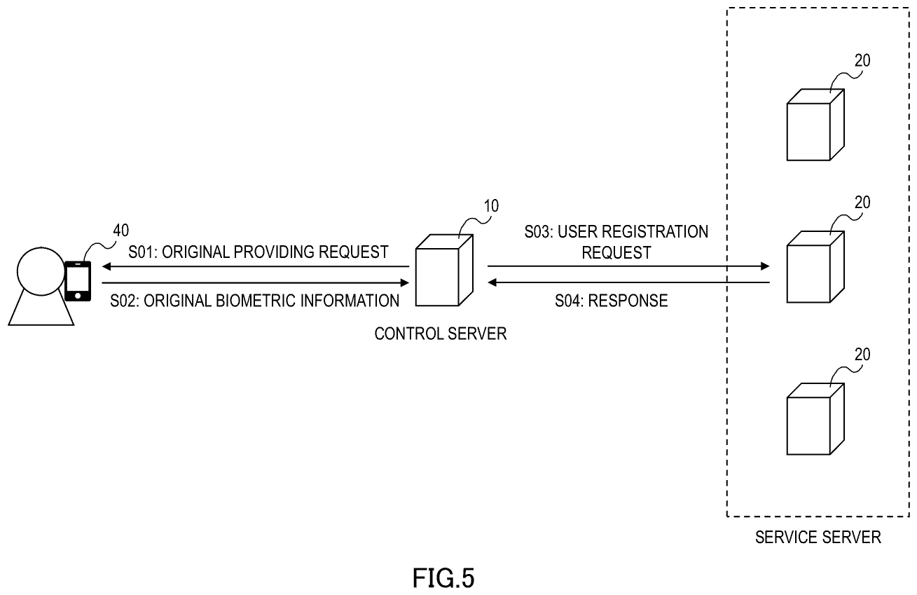

Once the service provider is identified, the control server 10 requests the user to provide original biometric information. Specifically, the control server 10 transmits an “original providing request” to the terminal 40 of the user (see step S01 in FIG. 5).

Upon receipt of the original providing request, the terminal 40 transmits the original biometric information of the user (for example, a face image) to the control server 10 (step S02).

The control server 10 notifies the service provider selected by the user (the first type of service provider) of the system ID of the user, the acquired original biometric information, personal identification information, and so on. Note that the personal identification information is information for identifying the user. Examples of the personal identification information include name of the user or a combination of name and date of birth. Alternatively, an employee number, a condominium room number, and so on may be used as the personal identification information.

The control server 10 transmits a “user registration request” including the system ID, original biometric information, and personal identification information to the service server 20 of the service provider selected by the user (step S03).

The service server 20 that has received the user registration request searches the user management database using the acquired personal identification information and identifies the user who wishes to be registered (be provided with a service using biometric authentication). The service server 20 stores the system ID and registered authentication information (for example, feature value) acquired from the original biometric information in an entry of the identified user.

The service server 20 transmits a response to the control server 10 including the result of user registration (success or failure in user registration) (step S04).

In this way, the user provides the original biometric information (master data of biometric information) stored in the terminal 40, such as a smartphone, to a service provider via the control server 10 of the authentication center. At that time, the terminal 40 continues to retain the original biometric information of the user (master data) internally.

Note that the control server 10 deletes the original biometric information (for example, a face image) acquired from the user at the timing of transmitting the user registration request to the service server 20 or at the timing of receiving a response to the request. In addition, the service server 20 deletes the original biometric information acquired from the control server 10 after generating registered authentication information (for example, feature value).

### Providing Service

After completing the selection of service, a user visits a service provider to receive a service. For example, the user visits a facility, a store, and so on of a service provider where the user receive the service selected by the user, such as an office, an amusement park, an event venue, and a retail store.

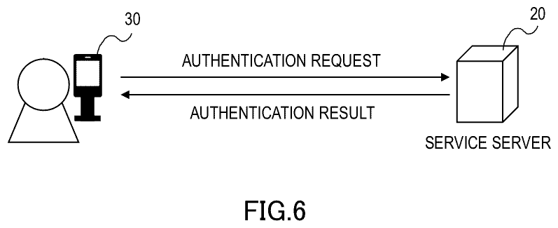

The authentication terminal 30 acquires biometric information of the user (person to be authenticated) who receives the service. For example, the authentication terminal 30 photographs the person to be authenticated and acquires biometric information (for example, a face image) corresponding to the original biometric information. The authentication terminal 30 transmits an authentication request including the acquired face image to the service server 20 (see FIG. 6). Note that the authentication terminal 30 transmits other information (for example, payment information such as the price related to the purchased product) together with biometric information to the service server 20, if necessary. Alternatively, the authentication terminal 30 may transmit to the service server 20 information used for authentication processing (for example, credit card information) along with biometric information (information for identifying an individual, ID).

The service server 20 generates authentication information for matching from the acquired face image. For example, the service server 20 generates a feature value from a face image for matching. The service server 20 performs a matching process (1-to-N matching; N is a positive integer, the same applies hereinafter) using the generated authentication information for matching (hereinafter referred to as “matching authentication information”) and registered authentication information registered in the user management database.

The service server 20 identifies the user (person to be authenticated) registered in the user management database by the matching process.

The service server 20 authenticates the user using operation information of the identified user. For example, the service server 20 at a company where the employee works determines “authentication success” if the person to be authenticated is an employee of his or her own company and is qualified to enter the office. Alternatively, the service server 20 installed at an event venue determines “authentication success” if the ticket purchased by the person to be authenticated is valid. Alternatively, the service server 20 installed at a retail store determines “authentication success” if the payment for a product, and so on purchased by the person to be authenticated is successfully settled.

The service server 20 transmits an authentication result (authentication success, authentication failure) to the authentication terminal 30.

The authentication terminal 30 performs an authentication processing in accordance with the result of authentication. For example, upon receiving an authentication success, the authentication terminal 30 installed at an office opens the gate and permits the person to be authenticated to pass through. Alternatively, upon receiving an authentication success, the authentication terminal 30 installed at an event venue permits the person to be authenticated to pass through the gate. Alternatively, upon receiving the authentication success, the authentication terminal 30 installed at the retail store notifies the person to be authenticated that payment for a product has been completed.

Next, details of the individual apparatuses included in the authentication system according to the first example embodiment will be described.

### Control Server

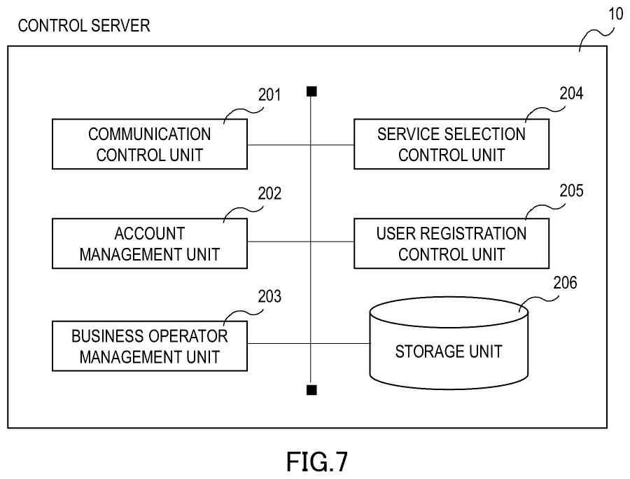

FIG. 7 is a diagram illustrating an example of a processing configuration (processing module) of the control server 10 according to the first example embodiment. Referring to FIG. 7, the control server 10 includes a communication control unit 201, an account management unit 202, a business operator management unit 203, a service selection control unit 204, a user registration control unit 205, and a storage unit 206.

The communication control unit 201 is means for controlling communication with other apparatuses. Specifically, the communication control unit 201 receives data (packets) from the service server 20. In addition, the communication control unit 201 transmits data to the service server 20. The communication control unit 201 hands over data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses

[symbol]

The account management unit 202 is means for managing user accounts. The account management unit 202 acquires information necessary to generate an account of a user when the user operates the terminal 40 to access a predetermined home page or the like.

Specifically, the account management unit 202 acquires personal information such as login information, name, date of birth, and so on. Upon acquiring the login information, and so on, the account management unit 202 generates a system ID to identify the user. The system ID may be any information as long as it can uniquely identify the user. For example, the account management unit 202 may assign a unique value to the system ID each time an account is created and use the unique value as the system ID.

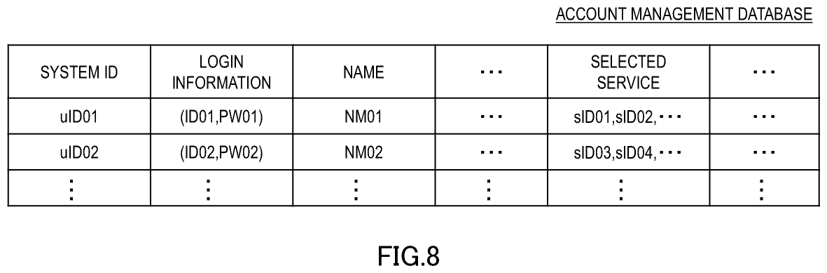

The account management unit 202 stores the generated system ID, login information, name, and so on in association with each other in the account management database (see FIG. 8). Note that the account management database shown in FIG. 8 is a diagram illustrating an example, and is not intended to limit the items to be stored, and so on. For example, the date and time of account generation, and so on may be stored in the account management database.

In addition, the account management unit 202 acquires login information from the terminal 40 of the user to log in to a portal site. The account management unit 202 performs authentication using the login information.

The business operator management unit 203 is means for managing service providers (business operators) participating in the authentication system. The business operator management unit 203 acquires business operator information to be registered in the system (name of service provider, type of business, location, management code, address of the service server 20, and so on) from a staff member, or the like of each service provider. The business operator information may include the type of each service provider (the first through fourth types of the service providers described above).

For example, the business operator management unit 203 may provide each service provider with an interface for inputting business operator information input, and so on. Alternatively, each service provider may send a USB (Universal Serial Bus) memory, or the like containing the business operator information, and so on, to the authentication center. The business operator management unit 203 may acquire the business operator information, and so on, from a staff member or the like of the authentication center.

The business operator management unit 203 generates an ID (business operator ID) for a service provider that has acquired the business operator information, and so on. The business operator management unit 203 associates and stores the generated business operator ID, the acquired business operator information, and so on.

The service selection control unit 204 is means for controlling selection of a biometric authentication service (service provider) by a user. The service selection control unit 204 enables the user to select the service provider from which the user wishes to receive a service from among a plurality of service providers that provide services using biometric authentication.

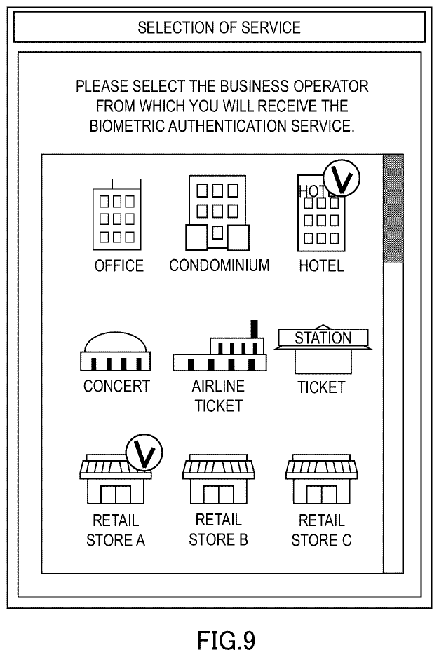

After the user logs in to a portal site by operating the terminal 40 and performs a predetermined operation on the portal site, the service selection control unit 204 displays a GUI on the terminal 40, for example, as shown in FIG. 9.

At the time of displaying the above GUI, the service selection control unit 204 performs a display that enables the user to distinguish between a service provider that has already been selected and a service provider that has not yet been selected. In the example in FIG. 9, a service provider with a check mark in the upper right corner of the icon indicating the service business operator indicates an already selected service provider, while a service provider without a check mark indicates an unselected service provider.

Note that the service selection control unit 204 uses the business operator information and information registered in the account management database to display a GUI such as the one shown in FIG. 9. Specifically, the service selection control unit 204 refers to the business operator information and generates a list of service providers that have a contract with the authentication center. Moreover, the service selection control unit 204 refers to the selection service field in the account management database and acquires the service provider (business operator ID of the service provider) that has already been selected by the user.

In addition, at the time of displaying the list of service providers, the service selection control unit 204 may also provide the user with more detailed information about each service provider (for example, type of business, services provided, store location, and so on).

Here, there are many companies and condominium management companies where users work, and it is not realistic to display a list of these companies and management companies. Therefore, the service selection control unit 204 may display icons that are representative of a plurality of service providers. In the example of FIG. 9, a plurality of companies (workplaces) are displayed as “office”, and a plurality of condominium management companies are displayed as “condominium”.

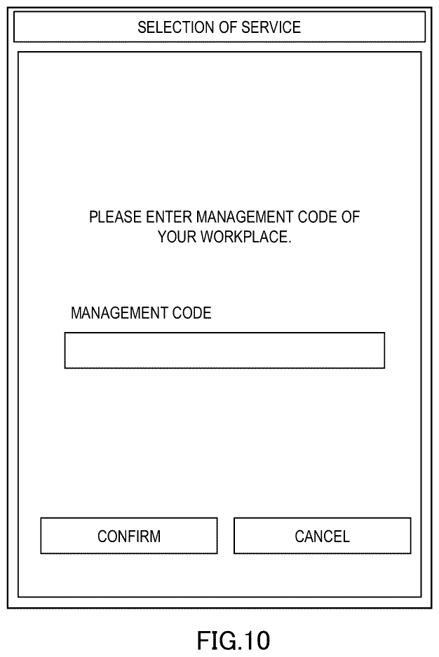

In the case where an icon representing the plurality of service providers is selected (when the icon of “office” or “condominium” is pressed in the example of FIG. 9), the service selection control unit 204 acquires a management code of the service provider which is the target of user registration. Specifically, the service selection control unit 204 acquires the management code using a GUI such as the one shown in FIG. 10. Note that the user acquires the management code for his or her own company or home condominium from their employer or management company, and so on.

The service selection control unit 204 identifies the service provider selected by the user from the management code. In this way, the service selection control unit 204 identifies the service provider selected (specified) by the user, by acquiring, as necessary, from the terminal 40 the management code corresponding to the service provider from which the user wishes to receive a service.

Note that in the case where an icon that does not represent the plurality of service providers (an icon that directly indicates a service provider; in the example of FIG. 9, the icons of retail stores A through C) is pressed, the service selection control unit 204 can identify the service provider selected by the user without using the management code.

The service selection control unit 204 hands over information on the service provider selected by the user (for example, the business operator ID of the service provider for which user registration is desired) to the user registration control unit 205.

Furthermore, the service selection control unit 204 enables the user to cancel a service provider who has already been selected by the user (to terminate to be provided with a service by the service provider). Specifically, after the user performs a predetermined operation on a portal site, the service selection control unit 204 displays a GUI such as the one shown in FIG. 9.

If a service provider for which user registration has already been performed in FIG. 9 (the service provider checked in the upper right corner in the example of FIG. 9) is selected, the service selection control unit 204 performs control to cancel the user registration of the selected service provider. Note that the service selection control unit 204 acquires, as necessary, the management code of the service provider for which user registration is to be cancelled.

The service selection control unit 204 hands over information on the service provider selected by the user (the service provider that the user wished to cancel the user registration) to the user registration control unit 205.

The user registration control unit 205 is means for controlling “user registration” by the control server 10. For example, the user registration control unit 205 performs control so that a service provider selected by the user using a predetermined code (management code) can acquire the original biometric information that serves as the original of authentication information to be used for biometric authentication.

The user registration control unit 205 controls “user registration” that enables the service provider selected by the user to provide the user with a service using biometric authentication. Alternatively, the user registration control unit 205 controls the cancellation of user registration.

The user registration control unit 205 performs user registration control in accordance with the type of service provider for which user registration is desired. The user registration control unit 205 acquires the type of selected service provider from the business operator information. In the first example embodiment, the case in which the first type of service provider is selected will be described. In other words, the user registration control unit 205 performs user registration control so that the service provider, the service provider not having accounts to manage customers, selected by a user and can acquire the original biometric information that serves as the original of authentication information to be used for biometric authentication.

After acquiring the information on the service provider selected by the user from the service selection control unit 204, the user registration control unit 205 transmits an “original providing request” to the terminal 40 possessed by the user. The user registration control unit 205 receives the original biometric information of the user (for example, a face image) from the terminal 40.

The user registration control unit 205 transmits a user registration request including the system ID of the user, original biometric information, and personal identification information, and so on to the service server 20 of the service provider corresponding to the service selected by the user.

Note that the user registration control unit 205 acquires the system ID and personal identification information (for example, name or a combination of name and date of birth) from the account management database.

The user registration control unit 205 receives a response (positive response, negative response) to the user registration request.

If a positive response (success in user registration) is received, the user registration control unit 205 registers the business operator ID of the service provider selected by the user in the account management database. If a positive response is received, the user registration control unit 205 notifies the user that the user registration related to the service provider selected by the user has been successful.

If a negative response (failure in user registration) is received, the user registration control unit 205 notifies the user of the fact.

If the user registration is desired to be cancelled, the user registration control unit 205 transmits a “registration cancellation request” including the system ID of the user to the service server 20 of the service provider for which the cancellation is desired.

The user registration control unit 205 receives a response (positive response, negative response) to the registration cancellation request. The user registration control unit 205 notifies the user of the result to the registration cancellation request.

Specifically, if a positive response (successful cancellation of registration) is received, the user registration control unit 205 notifies the user of the fact. For example, the user registration control unit 205 notifies the user that the user registration for the service provider selected by the user has been cancelled by unchecking the icon shown in FIG. 9. Alternatively, if the registration has been successfully cancelled, the user registration control unit 205 may display a message or the like indicating that the registered authentication information (for example, feature value) has been deleted from the service provider (the service server 20). In other words, the terminal 40 may report to the user that the feature value registered with the service server 20 has been deleted due to cancellation of registration. If a negative response (failure in registration cancellation) is received, the user registration control unit 205 notifies the user of the fact.

The storage unit 206 is means for storing information necessary for an operation of the control server 10.

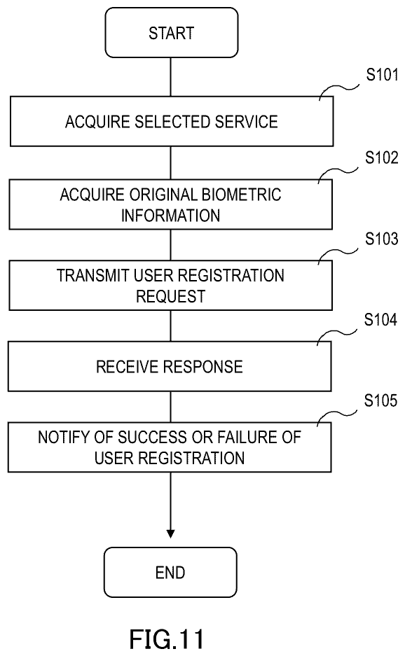

The flowchart shown in FIG. 11 summarizes the operations of the control server 10 described above with respect to user registration.

The control server 10 acquires a biometric authentication service (service provider) that a user wishes to receive (acquire a selected service; step S101). At that time, the control server 10 acquires the management code of the service provider, as necessary.

The control server 10 acquires original biometric information by transmitting an “original providing request” to the terminal 40 possessed by the user (step S102).

The control server 10 transmits a user registration request including a system ID, the acquired original biometric information (for example, a face image) and personal identification information (for example, name) to the service server 20 (step S103).

The control server 10 receives a response to a user registration request from the service server 20 (step S104).

The control server 10 notifies the user of a success or failure of the user registration (step S105).

In this way, the control server 10 acquires original biometric information by requesting the terminal 40 possessed by the user to provide the original biometric information, and transmits the acquired original biometric information to the service server 20 of the service provider selected by the user. At that time, the control server 10 transmits at least the system ID for managing the users in its own apparatus and the acquired original biometric information to the service server 20.

### Service Server

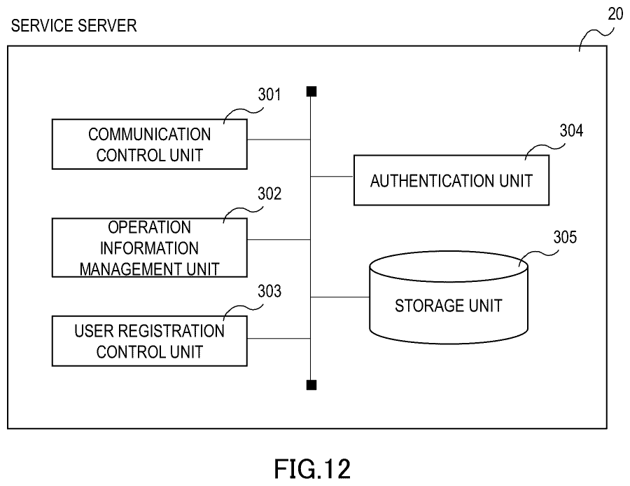

FIG. 12 is a diagram illustrating an example of a processing configuration (processing modules) of the service server 20 according to the first example embodiment. As illustrated in FIG. 12, the service server 20 includes a communication control unit 301, an operation information management unit 302, a user registration control unit 303, an authentication unit 304, and a storage unit 305.

The communication control unit 301 is means for controlling communication with other apparatuses. For example, the communication control unit 301 receives data (packets) from the control server 10. Also, the communication control unit 301 transmits data toward the control server 10. The communication control unit 301 hands over data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

The operation information management unit 302 is means for managing and controlling operation information necessary for a service provider to provide business.

The operation information management unit 302 acquires the operation information necessary to provide a service for its own company using any means. For example, the operation information management unit 302 of the company where the user works acquires information such as name, date of birth, employee number, department, and workplace of employees as operation information.

The operation information management unit 302 may acquire the above operation information from a staff member of the service provider, or the like, or may acquire the operation information directly from the user using means such as a home page.

The operation information management unit 302 manages the operation information using a user management database.

A more detailed description of the operation information management unit 302 will be omitted. This is because the details of operation information in individual services and the method of acquiring such information are different from a purpose of the present application.

The user registration control unit 303 is means for controlling user registration by the service provider. The user registration control unit 303 processes a user registration request received from the control server 10.

Upon receiving the user registration request, the user registration control unit 303 searches the user management database using the personal identification information (for example, name) included in the user registration request as a key, and identifies the corresponding user (entry).

If the corresponding user is registered in the user management database, the user registration control unit 303 generates registered authentication information from the acquired original biometric information (for example, a face image). For example, if the face image is acquired, the user registration control unit 303 generates a feature value (feature vector) corresponding to the face authentication algorithm adopted by its own company as the registered authentication information.

Note that since an existing technology can be used to generate the feature values, a detailed description thereof will be omitted. For example, the user registration control unit 303 extracts eyes, nose, mouth, and so on as feature points from the face image. After that, the user registration control unit 303 calculates the location of an individual feature point and the distance between feature points as the feature values and generates the feature vector formed by a plurality of feature values (vector information that characterizes the face image).

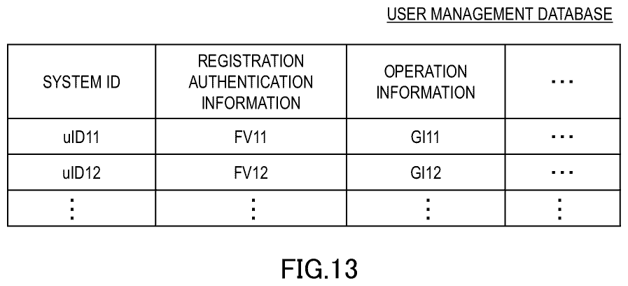

Once the registered authentication information (for example, feature value) is generated, the user registration control unit 303 associates and stores the user ID, the generated registered authentication information (feature value), and the operation information in the user management database (see FIG. 13).

Note that the user management database shown in FIG. 13 is an example, and is not meant to limit the items to be stored. For example, the date and time, and so on of user registration may be registered in the user management database.

After the user registration is successfully completed, the user registration control unit 303 transmits a positive response indicating that the user registration has been successful to the control server 10. Note that after the user registration control unit 303 generates registered authentication information (for example, feature value) and registers the generated registered authentication information in the user information database, the user registration control unit 303 deletes the original biometric information acquired from the control server 10.

If the user registration is not completed normally, the user registration control unit 303 transmits a negative response to the control server 10 indicating that the user registration has failed. For example, the negative response is transmitted to the control server 10 in the case where the personal identification information (for example, name) received from the control server 10 is not registered in the user management database or in the case where valid registered authentication information cannot be generated from the original biometric information.

Furthermore, the user registration control unit 303 processes a registration cancellation request received from the control server 10.

Once the user registration control unit 303 receives the registration cancellation request, the user registration control unit 303 searches the user management database using the system ID included in the registration cancellation request as a key to identify the corresponding user. The user registration control unit 303 deletes at least the system ID and registered authentication information (for example, feature value) of the identified user. Alternatively, the user registration control unit 303 deletes the entry of the identified user (entry in the user management database) as necessary.

If the system ID, and so on are successfully deleted, the user registration control unit 303 transmits a positive response to the control server 10 indicating that the user registration has been successfully cancelled. If the cancellation of user registration fails due to the reason that the system ID acquired from the control server 10 does not exist in the user management database, and so on, the user registration control unit 303 transmits a negative response to that effect to the control server 10.

The authentication unit 304 is means for performing a biometric authentication of a person to be authenticated. The authentication unit 304 receives an authentication request from the authentication terminal 30. The authentication unit 304 extracts biometric information (for example, a face image) from the authentication request.

The authentication unit 304 generates matching authentication information from the acquired biometric information. For example, upon acquiring a face image, the authentication unit 304 generates a feature value corresponding to a face authentication algorithm employed by its own company. The authentication unit 304 performs a matching processing using the generated matching authentication information (feature value) and the registered authentication information (feature value) registered in the user registration database.

Specifically, the authentication unit 304 calculates a similarity between the feature value (feature vector) as the matching target and each of the plurality of feature values registered. For the individual similarity, the chi-squared distance, the Euclidean distance, and so on may be used. A longer distance represents a lower similarity, and a shorter distance represents a higher similarity.

If there are no feature values whose similarity is greater than a predetermined value, the authentication unit 304 sets an authentication result to “authentication failure”.

If there is feature value whose similarity is greater than a predetermined value, the authentication unit 304 identifies the entry (user) with the most similar feature value (registered authentication information) among the plurality of entries registered in the user management database. The authentication unit 304 authenticates the person to be authenticated using the operation information of the identified user.

For example, if the user identified by the matching process is an employee of his or her own company and is qualified to enter the office, the authentication unit 304 at the workplace of the user determines that “authentication is successful”. Alternatively, if the identified user is an employee of his or her own company, but the employee is not qualified to enter the place where the authentication terminal 30 is installed, the authentication unit 304 determines that “authentication is failure.”

Note that a more detailed description of an authentication processing using operation information at each service provider will be omitted. This is because the processing specific to each service provider is different from the purpose of the present application.

The authentication unit 304 transmits the result of authentication (authentication success, authentication failure) to the authentication terminal 30.

The storage unit 305 is means for storing information necessary for the operation of the service server 20.

Note that, in principle, the service provider belonging to the first type continues to store the operation information used for authentication of the user. For example, the service server 20 continues to store the operation information until an employee retires or until a resident moves out. In other words, the service server 20 may delete the operation information upon retirement of an employee, and so on

[symbol]

### Authentication Terminal

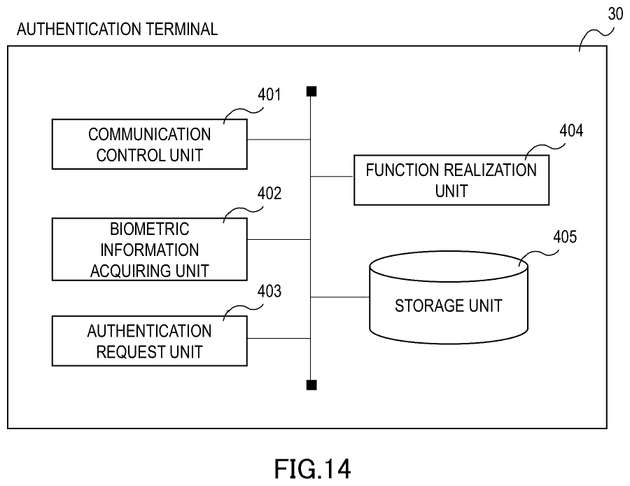

FIG. 14 is a diagram illustrating an example of a processing configuration (processing modules) of the authentication terminal 30 according to the first example embodiment. As illustrated in FIG. 14, the authentication terminal 30 includes a communication control unit 401, a biometric information acquiring unit 402, an authentication request unit 403, a function realization unit 404, and a storage unit 405.

The communication control unit 401 is means for controlling communication with other apparatuses. Specifically, the communication control unit 401 receives data (packets) from the service server 20. In addition, the communication control unit 401 transmits data to the service server 20. The communication control unit 401 hands over data received from other apparatuses to other processing modules. The communication control unit 401 transmits data acquired from other processing modules to other apparatuses. In this way, other processing modules transmit and receive data to and from other apparatuses via the communication control unit 401. The communication control unit 401 includes a function as a receiving unit that receives data from other apparatuses and a function as a transmitting unit that transmits data to other apparatuses.

The biometric information acquiring unit 402 controls a camera and acquires biometric information (for example, face image) of a person to be authenticated. The biometric information acquiring unit 402 captures an image of the area in front of its own apparatus on a regular basis or at a predetermined timing. The biometric information acquiring unit 402 determines whether the acquired image includes a human face image or not, and if a face image is included, extracts the face image from the acquired image data.

Note that an existing technique can be used for the face image detection and extraction processing performed by the biometric information acquiring unit 402, and therefore, detailed description thereof will be omitted. For example, the biometric information acquiring unit 402 may extract a face image (a face area) from the image data by using a learning model learned by a CNN (Convolutional Neural Network). Alternatively, the biometric information acquiring unit 402 may extract a face image by using a technique such as template matching.

The biometric information acquiring unit 402 hands over the extracted face image to the authentication request unit 403.

The authentication request unit 403 is means for requesting the service server 20 to perform an authentication of a person to be authenticated. When authentication of the person to be authenticated becomes necessary, the authentication request unit 403 transmits an authentication request including the biometric information of the person to be authenticated (the user in front of the authentication terminal 30) to the service server 20.

The authentication request unit 403 receives the result of authentication (authentication success, authentication failure) from the service server 20. The authentication request unit 403 hands over the received result of authentication to the function realization unit 404.

The function realization unit 404 is means for realizing a function allocated to the authentication terminal 30. For example, upon receiving the authentication success, the function realization unit 404 of the authentication terminal 30 installed at the workplace of the user opens the gate and permits the person to be authenticated to enter.

Note that a more detailed description of the function realization unit 404 included in the authentication terminal 30 of each service provider will be omitted. This is because function realization of the authentication terminal 30 by the function realization unit 404 is different from the purpose of the present application.

The storage unit 405 is means for storing information necessary for the operation of the authentication terminal 30.

### Terminal

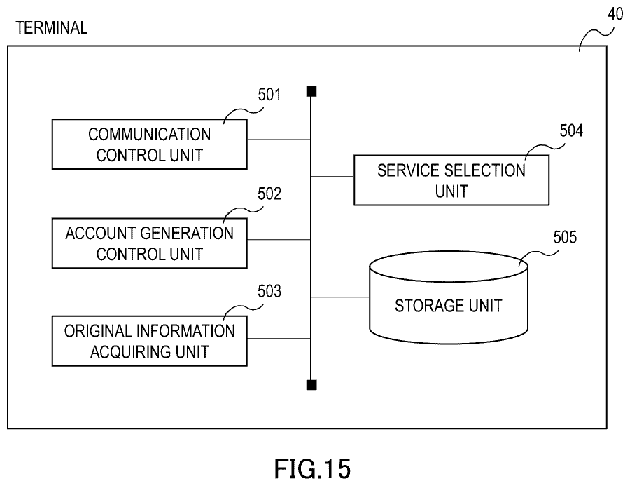

FIG. 15 is a diagram illustrating an example of a processing configuration (processing modules) of the terminal 40 according to the first example embodiment. As illustrated in FIG. 15, the terminal 40 includes a communication control unit 501, an account generation control unit 502, an original information acquiring unit 503, a service selection unit 504, and a storage unit 505

[symbol]

The communication control unit 501 is means for controlling communication with other apparatuses. For example, the communication control unit 501 receives data (packets) from the control server 10. Also, the communication control unit 501 transmits data toward the control server 10. The communication control unit 501 hands over data received from other apparatuses to other processing modules. The communication control unit 501 transmits data acquired from other processing modules to other apparatuses. In this way, other processing modules transmit and receive data to and from other apparatuses via the communication control unit 501. The communication control unit 501 includes a function as a receiving unit that receives data from other apparatuses and a function as a transmitting unit that transmits data to other apparatuses.

The account generation control unit 502 is means for controlling an account generation by a user. The account generation control unit 502 accesses a predetermined web page, or the like provided by the control server 10 in response to an operation of the user.

The account generation control unit 502 inputs login information, name, date of birth, and so on, on the web page in response to the operation of the user.

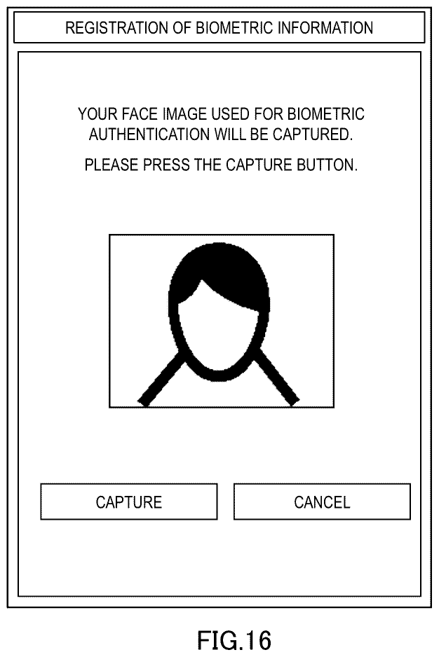

The original information acquiring unit 503 is means for acquiring the biometric information (original biometric information) of a user. The original information acquiring unit 503 displays a GUI, or the like for acquiring the original biometric information (for example, face image) in response to an operation of the user. For example, the original information acquiring unit 503 uses a GUI such as the one shown in FIG. 16 to acquire the original biometric information.

The original information acquiring unit 503 stores the acquired original biometric information (for example, a face image) in the storage unit 505. At that time, the original information acquiring unit 503 may encrypt, code, and so on the acquired original biometric information, and store the encrypted original biometric information in the storage unit 505. In other words, the terminal 40 possessed by the user may retain the encrypted original biometric information. The encrypted original biometric information may be decrypted at the time that the original biometric information is transmitted to the control server 10. Alternatively, information for decrypting the encrypted original biometric information (for example, a common key) may be shared between the terminal 40 and the control server 10, and the control server 10 may decrypt the encrypted original biometric information.

Note that, in principle, the terminal 40 does not delete the original biometric information (for example, face image) of a user. In other words, the terminal 40 does not delete the original biometric information stored in the storage unit 505 without a clear instruction from the user.

The service selection unit 504 is means for enabling a user to select a biometric authentication service. The service selection unit 504 logs in to a portal site provided by the control server 10 in response to an operation by a user. The service selection unit 504 transmits information of a service provider selected by the user to the control server 10 using a GUI provided by the control server 10.

The service selection unit 504 receives an original providing request from the control server 10. Upon receiving the request, the service selection unit 504 transmits the original biometric information stored in the storage unit 505 to the control server 10.

The storage unit 505 is means for storing information necessary for the operation of the terminal 40.

### System Operation

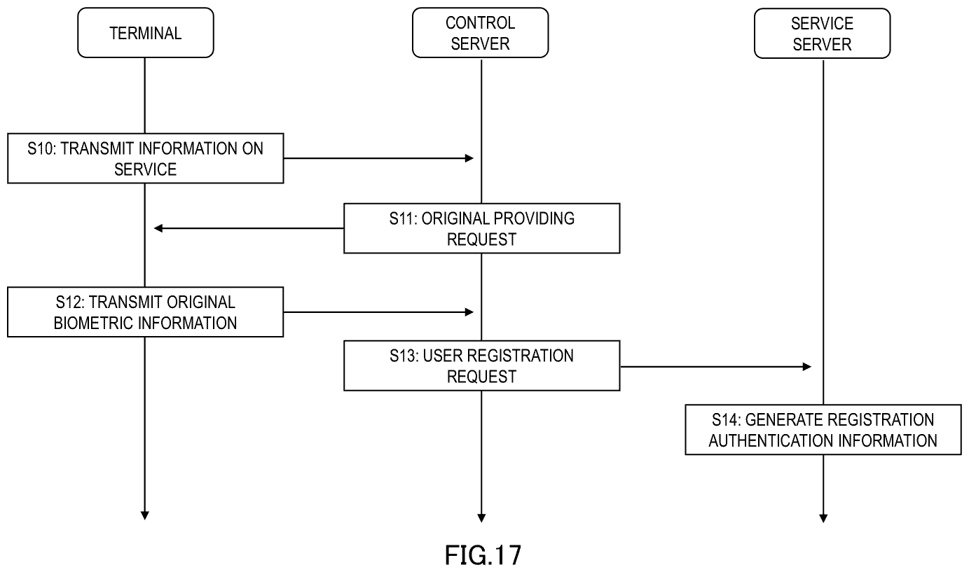

Next, operations in the authentication system according to the first example embodiment will be described. Note that the description of the operation related to account generation, or the like is omitted. FIG. 17 is a sequence diagram illustrating an example of an operation in the authentication system according to the first example embodiment.

The terminal 40 transmits information on the service selected by the user (information on the service provider from which the user wishes to receive a biometric authentication service) to the control server 10 (transmitting information on the service; step S10).

After the user selects the service he or she wishes to receive, the control server 10 transmits the original providing request to the terminal 40 of the user (Step S11).

In response to receipt of the original providing request, the terminal 40 transmits the original biometric information (for example, a face image) to the control server 10 (step S12).

The control server 10 transmits a user registration request including a system ID, the acquired original biometric information, and personal information, and so on, to the service server 20 of the service provider selected by the user (step S13).

The service server 20 generates authentication information for registration (registered authentication information) from the acquired original biometric information (step S14). The generated registered authentication information is registered in the user management database.

### Variation According to the First Example Embodiment

In the above example embodiment, the case in which the management code input by the user is used to identify the service provider selected by the user from among a plurality of service providers is described. However, the management code may also be used as information on whether the user is qualified or not to select a service provider. Specifically, the management code may be used as proof that the user is qualified to register a service provider (such as his or her workplace, condominium management company).

For example, once the user selects his or her workplace or a condominium management company, and so on, as a service provider, the control server 10 displays a list of workplaces, and so on, that have a contract with the authentication center on the terminal 40. Once the user selects a workplace, condominium management company, and so on from the displayed list, the control server 10 requests the user to input the management code of the workplace, and so on.

If the management code of the service provider selected by the user matches the management code input by the user, the control server 10 determines that the user is qualified to receive a service from the service provider. On the other hand, if the management code of the service provider selected by the user does not match the management code input by the user, the control server 10 determines that the user is not qualified to receive a service from the service provider. If the user is qualified to receive a service from the service provider, the control server 10 accepts user registration (selection of a service provider) with respect to the user. In this way, once a user selects a service provider from which the user wishes to receive a service, the service selection control unit 204 requests the user to input a first management code. If the first management code input by the user matches a predetermined second management code corresponding to the service provider selected by the user, the service selection control unit 204 accepts the selection of the user.

For example, if a user selects Workplace A and the user inputs the correct management code for Workplace A, the control server 10 determines that the user is qualified to register as a user with Workplace A. In this way, the control server 10 can also use the management code as a password. By using the management code as a password, the control server 10 can prevent user registration of a user who is unrelated to the service provider.

As described above, the control server 10 according to the first example embodiment performs control to acquire original biometric information that serves as the original of authentication information to be used for biometric authentication by a service provider belonging to the first type. The service provider belonging to the first type is a service provider who does not have accounts to manage customers and repeatedly uses operation information to provide a service to the customers. To enable such a service provider to acquire the original biometric information of a user (customer), the control server 10 transmits personal identification information (for example, name) along with the original biometric information of the user to the service server 20 of the service provider. The service server 20 identifies the user using the personal identification information and stores registered authentication information of the identified user in association with the operation information. Once the correspondence is completed, the service provider is able to provide the user with a service that uses biometric authentication.

Moreover, in the authentication system according to the first example embodiment, the original biometric information (for example, a face image) required for biometric authentication is stored in the terminal 40 of a user. Once the user wishes to receive a biometric authentication service, and after the user selects a service provider, the original biometric information stored in the terminal 40 is provided to the above selected service provider (the service provider requiring the registered authentication information). Once the user registers his or her biometric information (for example, a face image) on the terminal 40, the user can receive each service without registering his or her biometric information with each service (various service locations). That is, once the user takes a picture of his or her own face, the user can use the face authentication service without registering his or her face again in various places (services). In other words, with single registered authentication information, the biometric information can be applied to various solutions using biometric authentication.

In addition, the above configuration solves various problems that arise in providing a biometric authentication service by a service provider. In existing systems, the service provider has needed to have the user register his or her face image at each place of providing a service (service). However, in the system according to the first example embodiment, it is sufficient for the user to perform a single face registration, and the burden on the service provider in guiding the user to register his or her face is significantly reduced. Furthermore, the service provider does not need to retain the original biometric information (face image), which reduces the burden on the service provider against information leakage, and so on. In particular, in the case where the same service provider employs a plurality of face recognition algorithms, it is not necessary for the service provider to possess face images corresponding to each face recognition algorithm, thereby reducing management risk of the service provider. Moreover, with consent of the user, the authentication center stores the original biometric information, which allows the service provider to change a face recognition engine adopted by its own company, or to adopt a new face recognition engine that is suitable for a provided service. In other words, the service provider is not limited to a face recognition engine from a specific vendor, but can employ a face recognition engine from a variety of vendors that is suitable for the application. As a result, the service provider can avoid business risk of being overly dependent on one vendor (one face recognition engine). In other words, service providers who participate in the authentication system of the present application can easily support multiple vendors.

In addition, from the perspective of the user, there is no need to register a face image several times for the same service (the same service provider), which improves convenience for the user. Furthermore, since the original biometric information (face image) is kept on the user's own terminal 40 and the user's face image is not retained by an outside company, and so on, concerns about information leakage, and so on, are reduced. In other words, users can enjoy biometric authentication services with peace of mind.

### Second Example Embodiment

Next, a second example embodiment will be described in detail with reference to drawings.

In the second example embodiment, user registration with respect to the second type of service provider will be described.

As a configuration of the authentication system according to the second example embodiment can have the same configuration as that according to the first example embodiment, the description corresponding to FIG. 3 will be omitted. In addition, as a processing configuration of the control server 10 according to the second example embodiment can have the same processing configurations as that according to the first example embodiment, description thereof will be omitted.

The following description will be made with a focus on the difference between the first example embodiment and the second example embodiment.

As described above, a service provider belonging to the second type (for example, a management company of an amusement park, and so on, or an event company of a concert, and so on) does not provide a portal site to the user. The event company stores information on a ticket that a user has purchased on a ticket sales site, and so on, as operation information, and authenticates the user using the operation information.

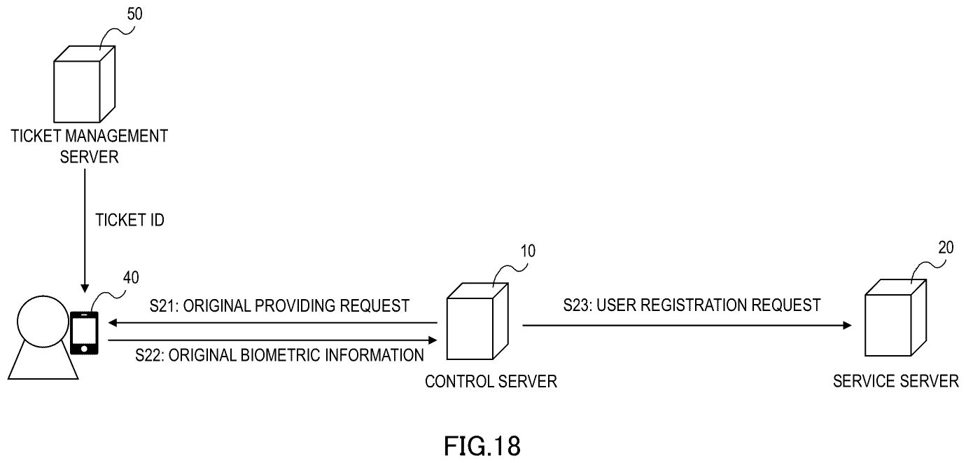

The user accesses a ticket sales site by operating the terminal 40 and purchases the desired ticket on the ticket sales site. Specifically, as shown in FIG. 18, the user operates the terminal 40 to access the ticket management server 50 to purchase a ticket. The terminal 40 acquires information on the purchased ticket. For example, the terminal 40 acquires an ID (ticket ID) from the ticket management server 50 to uniquely identify the purchased ticket.

Note that detailed descriptions related to the configuration, and so on of the ticket management server 50 and detailed descriptions related to purchasing a ticket and acquiring a ticket ID, and so on, will be omitted. This is because purchasing a ticket, and so on, is different from the purpose of the present application and is obvious to a person skilled in the art.

The user selects a service provider that belongs to the second type in a GUI such as the one shown in FIG. 9. For example, the user selects an event company that operates an amusement park, theme park, and so on. That is, the user accesses the control server 10 by operating the terminal 40 and selects the service provider which is the target of user registration. Note that the control server 10 acquires a management code that specifies a service provider from the user, as necessary.

The control server 10 determines the type of the selected service provider based on a business operator ID of the selected service provider. Here, the service provider belonging to the second type is selected. In the business operator information of the service provider that belongs to the second type, information on operation information required by the service provider is described. In the above example, the business operator information is described as requiring ticket information (ticket ID).

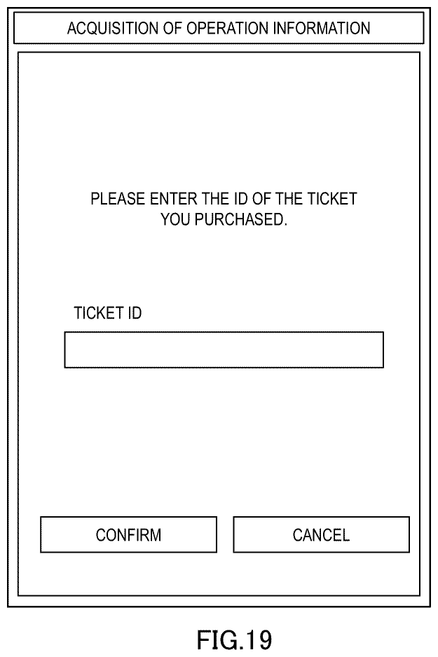

Once the second type of service provider is selected, the user registration control unit 205 of the control server 10 acquires the operation information required by the service provider. For example, the user registration control unit 205 acquires a ticket ID by displaying a GUI such as the one shown in FIG. 19 on the terminal 40.

After acquiring the ticket ID, the user registration control unit 205 acquires original biometric information from the terminal 40 of the user by transmitting an original providing request to the terminal 40 (steps S21 and S22 in FIG. 18), as in the first embodiment.

After acquiring the original biometric information, the user registration control unit 205 transmits a user registration request including the system ID, the above-mentioned acquired ticket ID (operation information) and the original biometric information to the service server 20 of the service provider (step S23).

The user registration control unit 303 of the service server 20 generates registered authentication information from the acquired biometric information. In addition, the user registration control unit 303 adds a new entry to the user management database and stores the system ID, registered authentication information, and operation information (ticket ID) in the added entry.

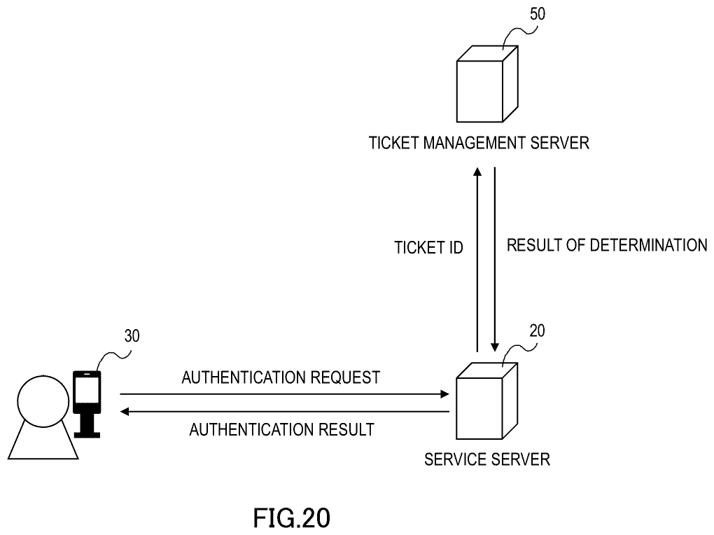

The service server 20 processes an authentication request received from the authentication terminal 30. Specifically, the authentication unit 304 of the service server 20 transmits the ticket ID of the person to be authenticated identified by a matching processing to the ticket management server 50 of the ticket sales site (see FIG. 20).

The ticket management server 50 determines the validity of the acquired ticket ID. Specifically, the ticket management server 50 determines the validity of the ticket based on the location of the event, date and time of the event, and so on of the ticket identified by the ticket ID. The ticket management server 50 transmits t the result of determination to the service server 20. The authentication unit 304 determines that the authentication has been successful if the ticket is valid. The authentication unit 304 determines that the authentication has failed if the ticket is invalid.

Note that, in principle, the service provider belonging to the second type deletes the operation information used for authentication of the user. This is because the operation information used by the service provider belonging to the second type (operation information needed for the service provider to provide a service to a customer; for example, ticket ID) is essentially information that is used once in biometric authentication. For example, once a ticket purchaser enters an event venue, the corresponding operation information is deleted because the ticket purchaser will not be determined to have been successfully authenticated again. Alternatively, in the case where re-entry to the event venue is permitted, the service server 20 may delete the corresponding operation information after the event is over (after a predetermined period of time has elapsed from the scheduled event end time).

Moreover, while the above description has been given using a ticket to an amusement park, concert, and so on as examples, it is of course not intended to limit the types of ticket. For example, the same processing can be applied to a boarding ticket for transportation, a passenger ticket, and so on. Furthermore, the tickets covered by the present application include not only tickets that are limited to a single use, but also tickets that are used a plurality of times. For example, a tour ticket (for example, a ticket that allows unlimited rides on means of transportation for a predetermined period of time), a commuter pass, and so on, which have a validity period, are also subject to the present application.

As described above, the control server 10 of the second example embodiment transmits to the service server 20, in addition to the system ID and original biometric information, the operation information (for example, ticket ID) required for the service provider selected by a user to provide a user with a service using biometric authentication. As a result, the service provider belonging to the second type can acquire the operation information (for example, ticket ID, and so on) required to provide a service for authentication of the user.

### Third Example Embodiment

Next, a third example embodiment will be described in detail with reference to drawings.

In the third example embodiment, user registration with respect to the third type of service provider will be described.

As a configuration of the authentication system according to the third example embodiment can have the same configuration as that according to the first example embodiment, the description corresponding to FIG. 3 will be omitted. In addition, as a processing configuration of the control server 10 according to the third example embodiment can have the same processing configurations as that according to the first example embodiment, description thereof will be omitted.

The following description will be made with a focus on the difference from the first example embodiment to the third example embodiment.

A user selects the service provider belonging to the third type in a GUI such as the one shown in FIG. 9. For example, the user selects a retail store such as a convenience store.

Note that the user who selects the service provider belonging to the third type already has an account with the service provider to be selected. For example, the user who wishes to use biometric authentication payment at a convenience store is a member of the convenience store and already has an account with the convenience store. Furthermore, payment information for the payment at the convenience store is stored as operation information in the account of the convenience store. The payment information includes information related to any payment method, such as information related to a credit card, information related to the amount charged to a transportation system IC (Integrated Circuit) card, information for code payment using a two-dimensional barcode.

The control server 10 enables biometric authentication payment by a user by performing control related to user registration for various retail stores such as convenience stores. The control server 10 links an account of a service provider selected by the user with an account of the authentication system.

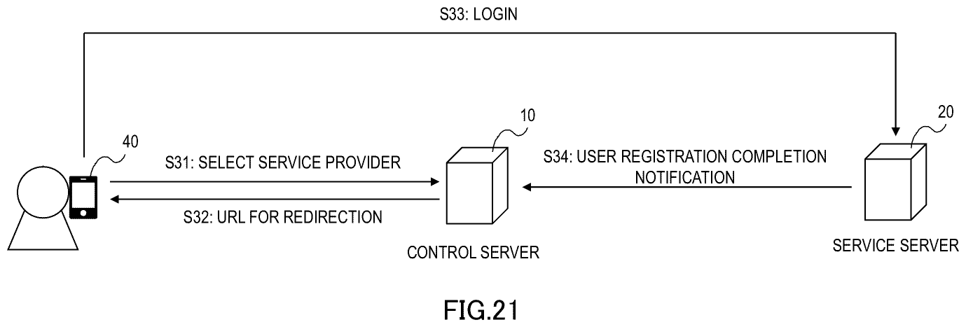

The user accesses the control server 10 by operating the terminal 40 and selects the service provider which is the target of user registration (account linking) (step S31 in FIG. 21).

The control server 10 determines the type of the selected service provider based on the business operator ID of the selected service provider. Here, the service provider belonging to the third type is selected.

Once the third type of service provider is selected, the user registration control unit 205 of the control server 10 transmits a URL (Uniform Resource Locator) to the terminal 40 to log in to the account of the selected service provider (step S32).

The URL transmitted to the terminal 40 is a URL for redirection to connect the terminal 40 to the login page of the service provider, and the system ID of the user is embedded in the URL for redirection. Note that the URL for redirection is provided to the control server 10 in advance as operation information. The user registration control unit 205 embeds the system ID (ID for the control server 10 to manage users) in the URL for redirection stored as operation information and transmits the URL for redirection to the terminal 40.

Upon receiving the URL for redirection, the terminal 40 accesses the login page of the service provider in accordance with the URL. At that time, since the URL for redirection includes the system ID, the user registration control unit 303 of the service server 20 can acquire the system ID of the user.

The user operates the terminal 40 and inputs login information (login information to log in to the account of the service provider) on the login page of the service provider (step S33).

The user registration control unit 303 of the service server 20 searches the user management database using the acquired login information (ID of a user) as a key to identify the corresponding user. The user registration control unit 303 stores the system ID acquired from the URL for redirection in the entry for the identified user. That is, the user registration control unit 303 stores the IDs of users managed by its own company (service provider) and the system IDs for the authentication system to manage users in association with each other.

In the following description, the ID issued by each service provider to manage users (customers, members, or the like) will be described as an “individual ID”. The user registration control unit 303 associates and stores the individual ID and system ID of the user who has logged in to a portal site according to the URL for redirection (links the IDs).

Once the correspondence between the individual ID and the system ID is completed, the user registration control unit 303 may notify the control server 10 of the system ID of the user. For example, the user registration control unit 303 may transmit a “user registration completion notification” including the system ID to the control server 10 (Step S34). The user registration control unit 205 of the control server 10 that receives the user registration completion notification may notify the user that the user registration has been completed.

For example, the control server 10 may notify the completion of user registration by checking the icon of a service provider whose user registration has been completed on a screen such as the one shown in FIG. 9.

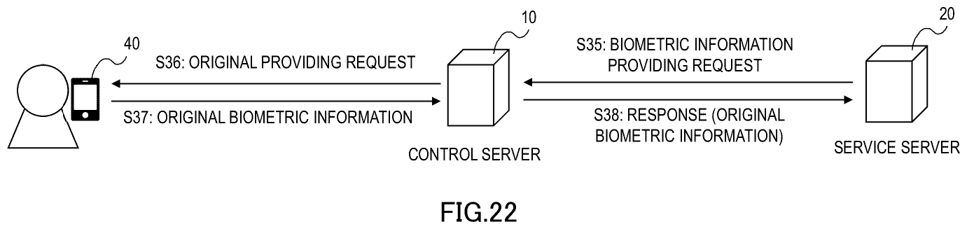

After the correspondence between the individual ID and the system ID is completed, the user registration control unit 303 of the service server 20 transmits a “biometric information providing request” including the system ID of the user to the control server 10 (step S35 in FIG. 22).

Upon receiving the biometric information providing request, the user registration control unit 205 of the control server 10 searches the account management database using the system ID included in the biometric information providing request as a key, and identifies the corresponding user. The user registration control unit 205 transmits an “original providing request” to the terminal 40 of the identified user (step S36).

In response to receiving the original providing request, the terminal 40 transmits original biometric information of the user (for example, a face image) to the control server 10 (step S37).

Upon acquiring the original biometric information, the user registration control unit 205 transmits the acquired original biometric information (for example, a face image) to the service server 20. Specifically, in the case where the original biometric information is acquired from the terminal 40, the user registration control unit 205 transmits a positive response including the acquired original biometric information to the service server 20 (step S38). Note that if the original biometric information cannot be acquired from the terminal 40, the user registration control unit 205 transmits a negative response to the service server 20 as a response to the biometric information providing request.

The user registration control unit 303 of the service server 20 generates registered authentication information from the acquired original biometric information and stores the registered authentication information in the user management database. The user registration control unit 303 stores the system ID, individual ID (login information), registered authentication information, and operation information (for example, credit card information) in association with each other in the user management database.

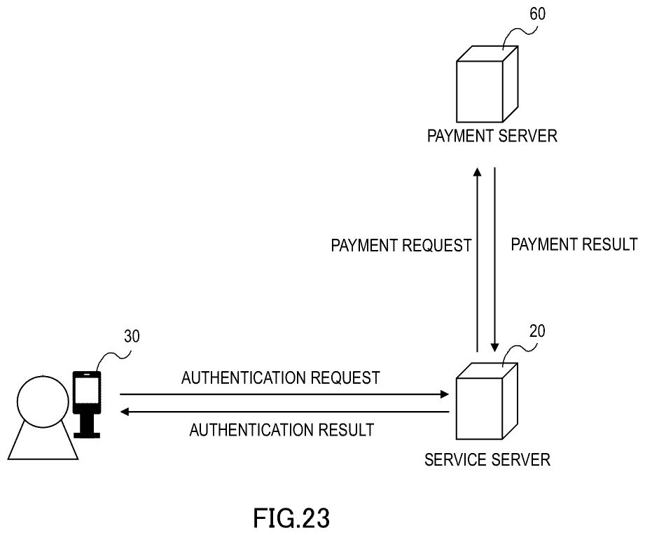

Once the user purchases a product at a retail store, the authentication terminal 30 transmits an authentication request including biometric information of the product purchase and payment information (purchase price) to the service server 20 (see FIG. 23). The service server 20 identifies the person to be authenticated (product purchaser) by matching processing using the acquired biometric information.

The service server 20 performs a payment processing using the credit card information and payment information of the identified person to be authenticated. Specifically, the service server 20 transmits the credit card information and payment information to a payment server 60 of the credit card company, thereby requesting the payment of the product price to the payment server 60. The payment server 60 notifies the service server 20 of the result of the payment processing. Note that the configuration and operation of the payment server 60 are different from the purpose of the present application and are obvious to those skilled in the art, so a detailed description will be omitted.

If notified that the payment is successful, the service server 20 determines that the authentication success is successful. If notified that the payment is failed, the service server 20 determines that the authentication is failed. The service server 20 notifies the authentication terminal 30 of the result of authentication.

Note that the service providers belonging to the third type repeatedly use operation information (for example, credit card information) required for authentication of the user. Therefore, even if the service server 20 successfully authenticates the user, the service server 20 does not delete the operation information and continues to store the operation information.

### System Operation

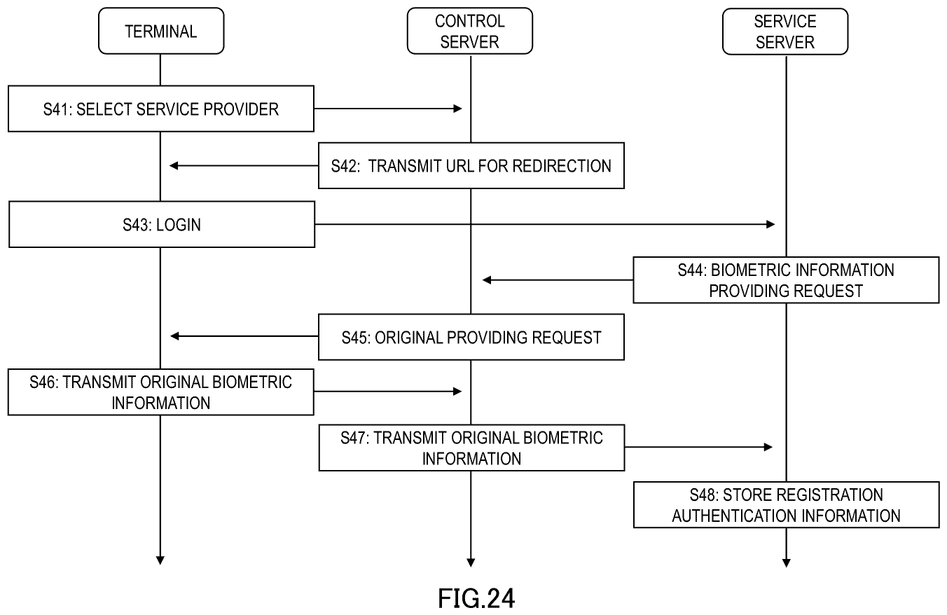

FIG. 24 is a sequence diagram illustrating an example of an operation in the authentication system according to the third example embodiment. Referring to FIG. 24, the operation of the authentication system according to the third example embodiment will be described.

The terminal 40 selects a service provider in response to an operation by a user (step S41).

Once the service provider belonging to the third type is selected, the control server 10 transmits the URL for redirection to the terminal 40 (step S42).

The terminal 40 accesses the login page indicated by the URL for redirection and logs in to a portal site in response to the operation by a user (Step S43). At that time, the service server 20 acquires the system ID embedded in the URL for redirection.

The service server 20 identifies the user using the login information (individual ID by which the service provider manage a user) and transmits a biometric information providing request related to the identified user to the control server 10 (step S44).

The control server 10 transmits the original providing request to the terminal 40 of the user (step S45).

The terminal 40 transmits the original biometric information (for example, a face image) to the control server 10 (step S46).

The control server 10 transmits the acquired original biometric information to the service server 20 (step S47).

The service server 20 generates registered authentication information (for example, feature value) from the acquired original biometric information (for example, a face image) and stores the registered authentication information in the user management database (step S48).

### Variation According to the Third Example Embodiment

In the third example embodiment, the case in which the service server 20 may transmit a “user registration completion notification” to the control server 10 after account linking (correspondence between the individual ID and the system ID) is completed is described. However, the service server 20 may transmit the above user registration completion notification to the control server 10 after registering the registered authentication information of the user in the user information management database.

As described above, the control server 10 according to the third example embodiment performs control to acquire the original biometric information that serves as the original of authentication information that a service provider belonging to the third type uses for biometric authentication. The service provider belonging to the third type is a service provider selected by the user, who has accounts for managing customers and who repeatedly uses operation information required to provide the services to the customers in the biometric authentication. The control server 10 transmits information to the terminal 40 of the user to log in to the account of the service provider selected by the user. The control server 10 acquires the original biometric information from the terminal 40 by requesting the terminal 40 to provide the original biometric information that serves as the original of authentication information used for biometric authentication in response to receiving a biometric information providing request from the service server 20 that manages account of the user. The control server 10 transmits the acquired original biometric information to the service server 20.

The service providers belonging to the third type have accounts (portal sites) to manage users and use individual IDs to manage the users. At the time of user registration (account linking, ID linking), the user logs in to a portal site in accordance with the URL for redirection in which the system ID is embedded, so that the service server 20 can acquire the system ID and individual ID of the user at the same time. In other words, unlike the first example embodiment, the service server 20 can use the individual ID to identify the user without using personal identification information, thus realizing more reliable user registration. That is, while the possibility of duplication of personal identification information (for example, name) cannot be eliminated, there is no possibility of duplication of individual IDs (the possibility of duplication is extremely low) because the individual ID is an ID issued by the service server 20 to each user. The service server 20 can realize reliable account linking (ID linking) by identifying the user using the individual ID. In this way, in the information processing system according to the third example embodiment, the information transmitted to the service server 20 via the control server 10 is limited to the original biometric information, and the personal identification information is not transmitted to the service server 20 via the control server 10. In the third example embodiment, information for identifying an individual (personal identification information) is transmitted to the service server 20 from the terminal 40 that acquired a URL for the redirection. In this way, the personal identification information is not transmitted from the control server 10 to the service server 20, which improves security strength of the system.

### Fourth Example Embodiment

Next, a fourth example embodiment will be described in detail with reference to drawings.

The fourth example embodiment describes user registration related to the fourth type of service provider.

As a configuration of the authentication system according to the fourth example embodiment can have the same configuration as that according to the first example embodiment, the description corresponding to FIG. 3 will be omitted. In addition, as a processing configuration of the control server 10, and so on according to the fourth example embodiment can have the same processing configurations as that according to the first example embodiment, description thereof will be omitted.

The following description will be made with a focus on the difference from the first example embodiment to the fourth example embodiment.

Basic operation of the system according to the fourth example embodiment can be the same as the operation of the system according to the third example embodiment. Specifically, once the service provider belonging to the fourth type is selected, each apparatus included in the authentication system performs an operation as shown in FIG. 21.

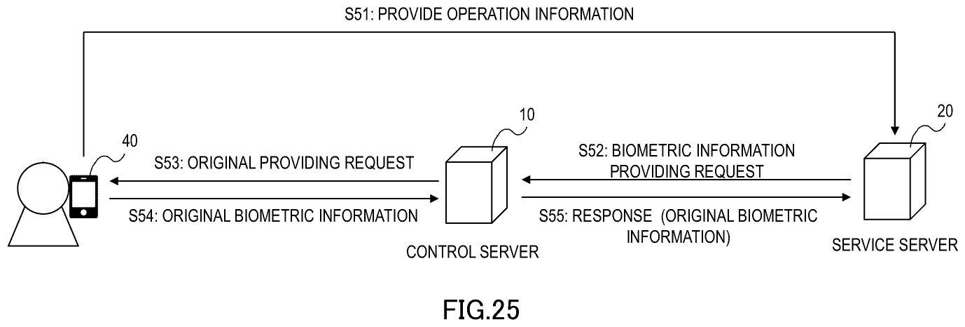

After ID linking of an ID of the service provider and the system ID of the authentication system is completed, the user provides operation information required to receive a service to the service provider (step S51 in FIG. 25). For example, the user purchases a ticket for a movie, concert, amusement park, airline ticket, train ticket, and so on at the portal site of the service provider to which the user has logged in.

Note that providing operation information (purchasing a ticket) may be performed in the process of logging in to the portal site of the service provider at the time of user registration. Alternatively, the user may log out of the portal site after completing user registration. The user may log in to the portal site again at a later date to purchase a ticket. In this case, the user may directly access (log in) to the portal site by operating the terminal 40.

The service server 20 stores information on tickets purchased by users. The operation information management unit 302 of the service server 20 stores operation information (ticket information) provided by the users in the user management database.

The user registration control unit 303 of the service server 20 accesses the user management database periodically or at a predetermined timing and refers to the operation information (ticket information) of each user. The user registration control unit 303 requests the control server 10 to provide biometric information a predetermined time before the referenced operation information (ticket information) becomes valid (a predetermined time before the referenced operation information is used in authentication processing).

Specifically, the user registration control unit 303 transmits a “biometric information providing request” including the system ID of a user (a user who may use the ticket after a predetermined time) to the control server 10 (step S52).

The control server 10 that has received the biometric information providing request transmits an original providing request to the terminal 40 to acquire original biometric information (for example, a face image) (steps S53 and S54). The control server 10 transmits the acquired original biometric information to the service server 20 (step S55).

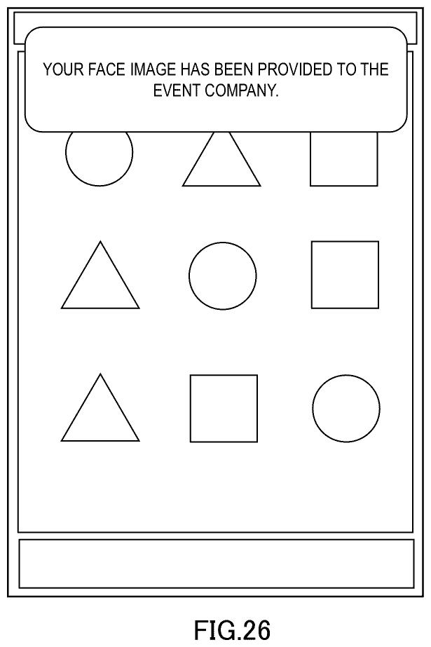

Note that in the fourth example embodiment, the timing at which the user selects a service provider and the timing at which the original biometric information (a face image) is provided to a service provider are often different. Therefore, the terminal 40 may notify the user of the fact that the original biometric information was transmitted to the control server 10 using a pop-up notification, and so on (see FIG. 26).

Once the authentication unit 304 of the service server 20 according to the fourth example embodiment receives an authentication request from the authentication terminal 30 installed at an event venue, and so on, the authentication unit 304 of the service server 20 determines the authentication result in accordance with whether or not the ticket of the user identified by the matching processing is valid. The authentication terminal 30 permits the user who has been determined to have been successfully authenticated (the user who possesses a valid ticket) to pass through the gate. The authentication terminal 30 refuses the user who has been determined to have failed authentication (the user who does not possess a valid ticket) to pass through the gate.

Note that, as with the second example embodiment, the service provider belonging to the fourth type deletes, in principle, the operation information used for authentication of the user. However, the service server 20 according to the fourth example embodiment leaves the account of the user (system ID, individual ID, and registered authentication information) without deleting the account. By leaving the account of the user, even if the user purchases a ticket for another concert, and so on, from the same service provider, user registration (ID linking, account linking) related to the service provider is no longer necessary.

As described above, the control server 10 according to the fourth example embodiment performs control to acquire original biometric information that serves as the original of authentication information to be used for biometric authentication by the service provider belonging to the fourth type. The service provider belonging to the fourth type is a service provider selected by a user, who has accounts for managing customers and uses operation information required to provide a service to customers substantially once in biometric authentication. The control server 10 transmits information to the terminal 40 of the user to log in to the account of the service provider selected by the user. The control server 10 acquires the original biometric information from the terminal 40 by requesting the terminal 40 to provide original biometric information that serves as the original of authentication information used for biometric authentication in response to receiving a biometric information providing request from the service server 20 that manages the account of the user. The control server 10 transmits the acquired original biometric information to the service server 20. As a result, reliable user registration (account linking, ID linking) is realized even for the service provider belonging to the fourth type. That is, in the fourth example embodiment, as in the third example embodiment, the information transmitted to the service server 20 via the control server 10 is limited to the original biometric information, and personal identification information is not transmitted to the service server 20 via the control server 10. In the fourth example embodiment, information for identifying an individual (personal identification information) is transmitted to the service server 20 from the terminal 40 that acquired the URL for redirection. In this way, the personal identification information is not transmitted from the control server 10 to the service server 20, which improves security strength of the system.

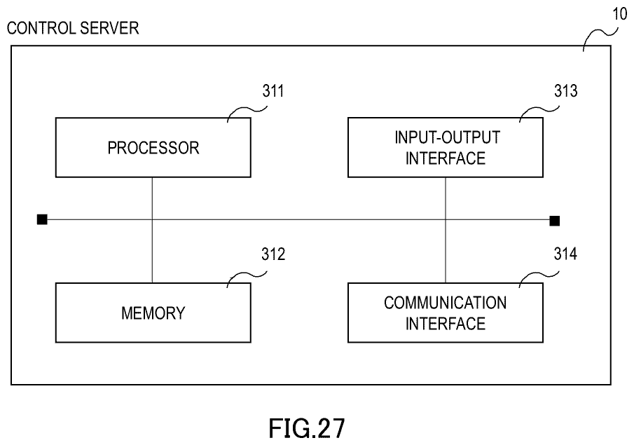

Next, a hardware configuration of an individual apparatus that constitutes the authentication system will be described. FIG. 27 is a diagram illustrating an example of a hardware configuration of the control server 10.

The control server 10 can be configured by an information processing apparatus (a so-called computer) and has a configuration illustrated as an example in FIG. 27. For example, the control server 10 includes a processor 311, a memory 312, an input-output interface 313, a communication interface 314, and so on. The components such as the processor 311 are connected to an internal bus, and so on so that these components can communicate with each other.

The hardware configuration of the control server 10 is not limited to the configuration illustrated in FIG. 27. The control server 10 may include hardware not illustrated or may be configured without the input-output interface 313 if desired. In addition, the number of components, such as the number of processors 311, included in the control server 10 is not limited to the example illustrated in FIG. 27. For example, a plurality of processors 311 may be included in the control server 10.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), and so on. The memory 312 stores an OS program, an application program, and various kinds of data.

The input-output interface 313 is an interface for a display apparatus and an input apparatus not illustrated. For example, the display apparatus is a liquid crystal display and so on. For example, the input apparatus is an apparatus that receives user operations, and examples of the input apparatus include a keyboard and a mouse.

The communication interface 314 is a circuit, a module, and so on for performing communication with other apparatuses. For example, the communication interface 314 includes a NIC (Network Interface Card) and so on.

The functions of the control server 10 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

As is the case with the control server 10, the service server 20, the authentication terminal 30, the terminal 40, and so on can each be configured by an information processing apparatus, and the basic hardware configuration of the service server 20, the authentication terminal 30, the terminal 40, and so on is the same as that of the control server 10. Thus, description of the basic hardware configuration of the service server 20, the authentication terminal 30, the terminal 40, and so on will be omitted. For example, the authentication terminal 30 may be equipped with a camera device for photographing the person to be authenticated.

The control server 10, which is an information processing apparatus, includes a computer, and the functions of the control server 10 can be realized by causing the computer to execute a program. In addition, the control server 10 executes a control method of the control server 10 by using this program. Similarly, the terminal 40, which is an information processing apparatus, includes a computer and can realize its functions by causing the computer to execute a program. In addition, the terminal 40 executes a terminal control method by using this program.

### Variations

The configurations, operations, and so on of the authentication systems according to the above example embodiments are examples and do not limit the present system configuration, and so on.

In the above embodiment, an operation of an authentication system is described using “face” of a person as an example of biometric information. However, the authentication system of the present application can also use other types of biometric information. For example, data with physical characteristics unique to the individual, such as fingerprints, voice prints, veins, retinas, and iris patterns of the eyes, may be used. That is, the biometric information of a user may be any information including physical features of the user.

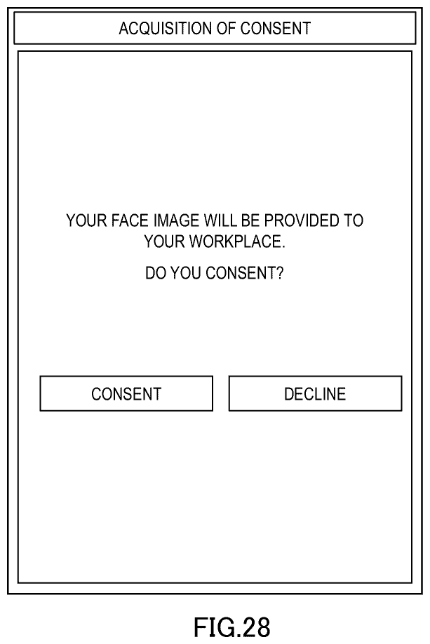

Each time the terminal 40 of the user receives an original providing request from the control server 10, the terminal 40 of the user may acquire consent from the user to transmit the original biometric information (for example, a face image) to the service provider. Specifically, upon receiving the original providing request, the service selection unit 504 of the terminal 40 acquires whether or not the original biometric information (for example, a face image) can be provided using a GUI such as the one shown in FIG. 28. After acquiring the consent of the user with regard to providing the original biometric information, the service selection unit 504 transmits the original biometric information stored inside to the control server 10.

In the above example embodiments, the case in which the service server 20 generates authentication information (feature value) corresponding to an authentication engine employed by its own company is described. However, generation of the authentication information (feature value) may also be performed by the control server 10. Specifically, the control server 10 stores information on the authentication engine employed by the service provider as part of the business operator information. The control server 10 may generate registration authentication information (feature value) that conforms to the above authentication engine from the original biometric information acquired from the terminal 40, and transmit a user registration request including the generated registration authentication information to the control server 10.

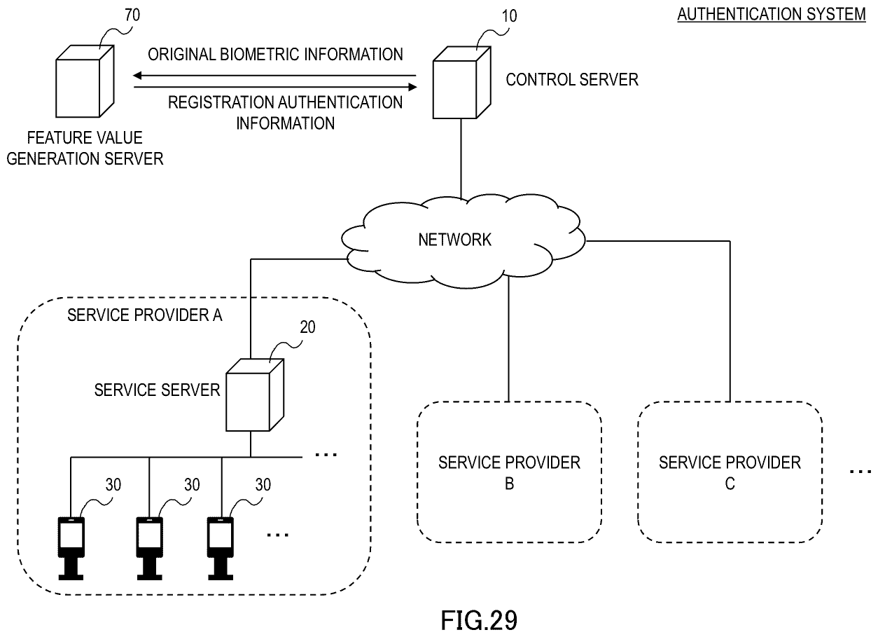

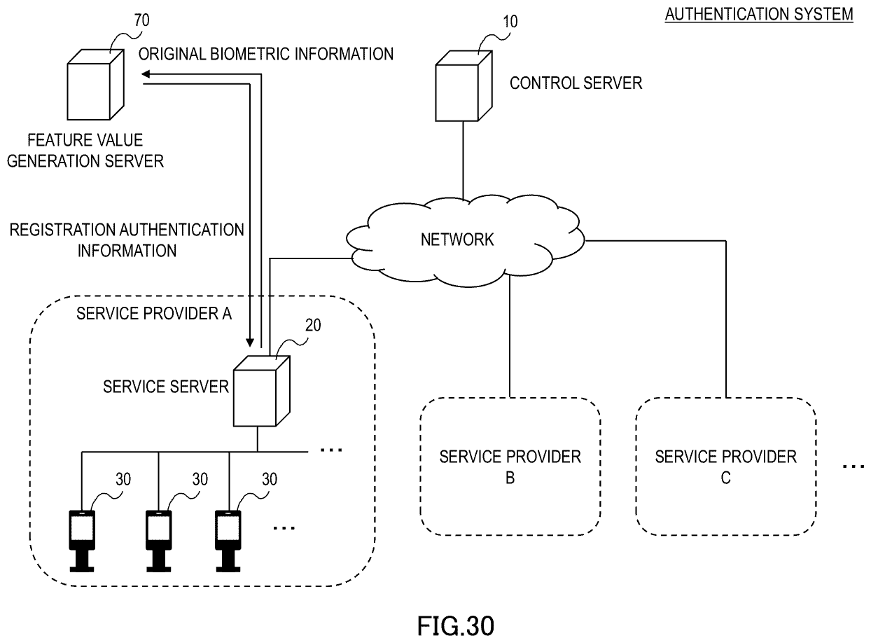

Alternatively, the service server 20 or the control server 10 may transmit original biometric information to a server specialized in generating a feature value (feature value generation server 70), as shown in FIG. 29 and FIG. 30, and acquire registered authentication information from the server. In the case where the control server 10 or the service server 20 transmits the original biometric information (for example, a face image) to the feature value generation server 70, the control server 10 or the service server 20 may also transmit information on the authentication engine employed by the service provider to the feature value generation server 70. The feature value generation server 70 may generate registered authentication information (for example, a feature value) that conforms to an authentication engine (authentication algorithm) specified by the control server 10 or the service server 20, and send return the registered authentication information to the control server 10 or the service server 20. In this way, the registered authentication information (feature value) may be generated either on the cloud side (the control server 10 side) or on the edge side (the service server 20 side). Note that the configuration and operation of the feature value generation server 70 are obvious from the above description, so a detailed description will be omitted.

In the above example embodiments, the case in which the control server 10 identifies the service provider which is the target of user registration by using a management code of the workplace, and so on of a user is described. However, the control server 10 may identify the service provider which is the target of user registration by using other methods. For example, the control server 10 may provide an interface to select the service provider which is the target of user registration from search results using a company name, and so on, or may display a list of service providers in Japanese syllabary order on the terminal 40.

In the first example embodiment, a user (employee) may register information on a visitor (guest) to the office in the system. In this case, the employee accesses the control server 10 by operating the terminal 40 and performs a registration procedure for a guest. The control server 10 acquires the name, affiliation, contact information, and so on of the guest from the employee. The control server 10 transmits a face image registration request to the acquired contact information (a terminal of the guest). For example, the control server 10 transmits a face image registration request that includes a URL. Once the guest clicks on the URL, the terminal of the guest accesses the control server 10. The control server 10 acquires a face image of the guest and transmits the face image to the service server 20 in the office.

In addition, the service server 20 in the office may control the behavior of a guest using biometric authentication. For example, at the time that a guest is entering a conference room, the service server 20 may determine whether or not the guest is permitted to enter the conference room using biometric authentication. Alternatively, the service server 20 may control a use of beverages, and so on, by the guest by biometric authentication. For example, the service server 20 may perform a control such that a vending machine in the office provides a free drink to the guest only once.

In the case where the user does not have an account at the service provider belonging to the selected third or fourth type, the user may generate an account at a login page to which the user is redirected by a URL for redirection. In other words, the service server 20 may display guidance on account generation for a new customer, and so on, on the login page.

The control server 10 may check the identity of the user at the time of account generation. Specifically, the control server 10 acquires an identity verification document in which biometric information is described (for example, passport, driver's license, and so on) and the biometric information, along with the login information, and so on, of the user. The control server 10 performs a one-to-one matching using the biometric information from the identity verification document and the biometric information acquired from the user. In the case where the matching is successful, the control server 10 may perform user registration (system registration) of the user whose identity has been successfully verified.

In the above example embodiments, the case where the account management database is configured inside the control server 10 is described, however, the database may be constructed on an external database server, and so on. That is, some functions of the control server 10 may be implemented in another server. More specifically, the “service selection control unit (service selection control means)” and so on described above can be implemented in any of the apparatuses included in the system.

While the form of data transmission and reception between each apparatus (the control server 10, the service server 20, and the authentication terminal 30) is not particularly limited, the data transmitted and received between these apparatuses may be encrypted. It is desirable that the biometric information and so on are transmitted and received between these apparatuses and encrypted data is transmitted and received in order to properly protect this information.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to information processing systems, and so on, that provide biometric authentication services.

A part or the entirety of the example embodiments described above may be described as in the following supplementary notes, but is not limited to the followings.

### Supplementary Note 1

A server apparatus, including:
a service selection control means that enables a user to select a service provider from which the user wishes to receive a service using a predetermined code from among a plurality of service providers that provide services using biometric authentication; and
a user registration control means that performs control so that the service provider selected by the user acquires original biometric information that serves as an original of authentication information to be used for the biometric authentication.

### Supplementary Note 2

The server apparatus according to supplementary note 1, wherein the registration control means acquires the original biometric information by requesting a terminal possessed by the user to provide the original biometric information, and transmits the acquired original biometric information to a server of the service provider selected by the user.

### Supplementary Note 3

The server apparatus according to supplementary note 2, wherein the user registration control means transmits a system ID for managing the user in own apparatus and the acquired original biometric information to the server.

### Supplementary Note 4

The server apparatus according to supplementary note 3, wherein the user registration control means, in addition to the system ID and the original biometric information, transmits operation information required for the service provider selected by the user to provide the user with the service using the biometric authentication to the server.

### Supplementary Note 5

The server apparatus according to supplementary note 4, wherein the predetermined code is a management code corresponding to the service provider from which the user wishes to receive the service.

### Supplementary Note 6

The server apparatus according to supplementary note 1, wherein the service selection means, once the user selects the service provider from which the user wishes to receive the service, requests the user to input a first management code, and, if the first management code input by the user matches a predetermined second management code corresponding to the selected service provider, accepts a selection of the service provider by the user.

### Supplementary Note 7

The server apparatus according to any one of supplementary notes 1 to 6, wherein the original biometric information is a face image.

### Supplementary Note 8

A system, including:
a terminal possessed by a user; and
a server apparatus,
wherein the server apparatus, including:
a service selection control means that enables a user to select a service provider from which the user wishes to receive a service using a predetermined code from among a plurality of service providers that provide services using biometric authentication; and
a user registration control means that performs control so that the service provider selected by the user acquires original biometric information that serves as an original of authentication information to be used for the biometric authentication,
wherein the user registration control means acquires the original biometric information by requesting the terminal possessed by the user to provide the original biometric information, and transmits the acquired original biometric information to a server of the service provider selected by the user.

### Supplementary Note 9

A control method of a server apparatus, the control method including:
enabling a user to select a service provider from which the user wishes to receive a service using a predetermined code from among a plurality of service providers that provide services using biometric authentication; and
performing control so that the service provider selected by the user acquires original biometric information that serves as an original of authentication information to be used for the biometric authentication.

### Supplementary Note 10

A computer-readable storage medium storing a program causing a computer mounted on a server apparatus to perform processing for:
enabling a user to select a service provider from which the user wishes to receive a service using a predetermined code from among a plurality of service providers that provide services using biometric authentication; and
performing control so that the service provider selected by the user acquires original biometric information that serves as an original of authentication information to be used for the biometric authentication.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and spirit of the present invention. That is, the present invention of course includes various variations and modifications that could be made by those skilled in the art in accordance with the overall disclosure including the claims and the technical concept.

### REFERENCE SIGNS LIST

10 control server
20 service server
30 authentication terminal
40 terminal
50 ticket management server
60 payment server
70 feature value generation server
100 server apparatus
101 service selection control means
102 user registration control means
201 communication control unit
202 account management unit
203 business operator management unit
204 service selection control unit
205 user registration control unit
206 storage unit
301 communication control unit
302 operation information management unit
303 user registration control unit
304 authentication unit
311 processor
312 memory
313 input-output interface
314 communication interface
401 communication control unit
402 biometric information acquiring unit
403 authentication request unit
404 function realization unit
405 storage unit
501 communication control unit
502 account generation control unit
503 original information acquiring unit
504 service selection unit
505 storage unit

What is claimed is:

1. A server apparatus, comprising:
at least one memory storing a set of instructions; and
at least one processor configured to execute the set of instructions to:
enable a user to select a service provider from which the user wishes to receive a service using a predetermined code from among a plurality of service providers that provide services using biometric authentication; and
perform control so that the service provider selected by the user acquires original biometric information that serves as an original of authentication information to be used for the biometric authentication.

2. The server apparatus according to claim 1, wherein the at least one processor is further configured to execute the set of instructions to:
acquire the original biometric information by requesting a terminal possessed by the user to provide the original biometric information; and
transmit the acquired original biometric information to a server of the service provider selected by the user.

3. The server apparatus according to claim 2, wherein
the at least one processor is further configured to execute the set of instructions to transmit a system ID for managing the user in own apparatus and the acquired original biometric information to the server.

4. The server apparatus according to claim 3, wherein
the at least one processor is further configured to execute the set of instructions to transmit, in addition to the system ID and the original biometric information, operation information required for the service provider selected by the user to provide the user with the service using the biometric authentication to the server.

5. The server apparatus according to claim 4, wherein the predetermined code is a management code corresponding to the service provider from which the user wishes to receive the service.

6. The server apparatus according to claim 1, wherein
the at least one processor is further configured to execute the set of instructions to:
requests the user to input a first management code once the user selects the service provider from which the user wishes to receive the service; and
accept a selection of the service provider by the user if the first management code input by the user matches a predetermined second management code corresponding to the selected service provider.

7. The server apparatus according to claim 1, wherein the original biometric information is a face image.

8. A system, comprising:
a terminal possessed by a user; and
a server apparatus,
wherein the server apparatus, comprising:
at least one memory storing a set of instructions; and
at least one processor configured to execute the set of instructions to:
enable a user to select a service provider from which the user wishes to receive a service using a predetermined code from among a plurality of service providers that provide services using biometric authentication; and
perform control so that the service provider selected by the user acquires original biometric information that serves as an original of authentication information to be used for the biometric authentication,
wherein the at least one processor is further configured to execute the set of instructions to:
acquire the original biometric information by requesting the terminal possessed by the user to provide the original biometric information; and
transmit the acquired original biometric information to a server of the service provider selected by the user.

9. A control method of a server apparatus, the control method comprising:
enabling a user to select a service provider from which the user wishes to receive a service using a predetermined code from among a plurality of service providers that provide services using biometric authentication; and
performing control so that the service provider selected by the user acquires original biometric information that serves as an original of authentication information to be used for the biometric authentication.

10. (canceled)
